(19) United States
(12) Patent Application Publication
(10) Pub. No.: US 2025/0267282 A1
(43) Pub. Date: Aug. 21, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Junru LI, Beijing (CN); Kai ZHANG, Los Angeles, CA (US); Li ZHANG, Los Angeles, CA (US)

(21) Appl. No.: 19/177,459

(22) Filed: Apr. 11, 2025

Related U.S. Application Data
(63) Continuation of application No. PCT/CN2023/124366, filed on Oct. 12, 2023.

(30) Foreign Application Priority Data
Oct. 13, 2022 (WO) PCT/CN2022/125228

(51) Int. Cl. H04N 19/147; H04N 19/117; H04N 19/184

(52) U.S. Cl. CPC H04N 19/147; H04N 19/117; H04N 19/184

(57) ABSTRACT

Embodiments of the present disclosure provide a solution for video processing. A method for video processing is proposed. The method comprises: determining, for a conversion between a video unit of a video and a bitstream of the video unit, whether to apply at least one neural network (NN) filter model or determine a rate distortion cost during a rate distortion optimization (RDO) process of the video unit based on at least one of: a distortion without NN filter model, a distortion with n-th NN filter model, a combination of distortions of a plurality of NN filter models, or coding statistics of the video unit, and wherein n is an integer number; determining a coding mode of the video unit based on a rate distortion optimization (RDO) criterion in the RDO process; and performing the conversion based on the coding mode.

### CROSS REFERENCE

This application is a continuation of International Application No. PCT/CN2023/124366, filed on Oct. 12, 2023, which claims the benefit of International Application No. PCT/CN2022/125228, filed on Oct. 13, 2022. The entire contents of these applications are hereby incorporated by reference in their entireties.

### FIELDS

Embodiments of the present disclosure relates generally to video processing techniques, and more particularly, to neural network (NN) in-loop filtering based content-adaptive rate distortion optimization for image/video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video unit, whether to apply at least one neural network (NN) filter model or determine a rate distortion cost during a rate distortion optimization (RDO) process of the video unit based on at least one of: a distortion without NN filter model, a distortion with n-th NN filter model, a combination of distortions of a plurality of NN filter models, or coding statistics of the video unit, and wherein n is an integer number; determining a coding mode of the video unit based on a rate distortion optimization (RDO) criterion in the RDO process; and performing the conversion based on the coding mode. In this way, the impact of reduce distortion due to NN filter is taken into consideration during the RDO process, thereby improving coding performances.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining whether to apply at least one neural network (NN) filter model or determine a rate distortion cost during a rate distortion optimization (RDO) process of a video unit of the video based on at least one of: a distortion without NN filter model, a distortion with n-th NN filter model, a combination of distortions of a plurality of NN filter models, or coding statistics of the video unit, and wherein n is an integer number; determining a coding mode of the video unit based on a rate distortion optimization (RDO) criterion in the RDO process; and generating the bitstream based on the coding mode.

In a fifth aspect, a method for storing a bitstream of a video is proposed. The method comprises: determining whether to apply at least one neural network (NN) filter model or determine a rate distortion cost during a rate distortion optimization (RDO) process of a video unit of the video based on at least one of: a distortion without NN filter model, a distortion with n-th NN filter model, a combination of distortions of a plurality of NN filter models, or coding statistics of the video unit, and wherein n is an integer number; determining a coding mode of the video unit based on a rate distortion optimization (RDO) criterion in the RDO process; generating the bitstream based on the coding mode; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing an example of raster-scan slice partitioning of a picture;

FIG. 5 illustrates an example diagram showing an example of rectangular slice partitioning of a picture;

FIG. 6 illustrates an example diagram showing an example of a picture partitioned into tiles, bricks, and rectangular slices;

FIG. 7A illustrates an example diagram showing CTBs crossing the bottom picture border;

FIG. 7B illustrates an example diagram showing CTBs crossing the right picture border;

FIG. 7C illustrates an example diagram showing CTBs crossing the right bottom picture border;

FIG. 8 illustrates an example diagram showing an example of encoder block diagram;

FIG. 9 illustrates an example diagram showing an illustration of picture samples and horizontal and vertical block boundaries on the 8×8 grid, and the nonoverlapping blocks of the 8×8 samples;

FIG. 10 illustrates an example diagram showing pixels involved in filter on/off decision and strong/weak filter selection;

FIGS. 11A-11D illustrate example diagrams showing four 1-D directional patterns for EO sample classification;

FIGS. 12A-12C illustrate example diagrams showing examples of GALF filter shapes;

FIGS. 13A-13C illustrate example diagrams showing examples of relative coordinator for the 5×5 diamond filter support;

FIG. 14 illustrates an example diagram showing examples of relative coordinates for the 5×5 diamond filter support;

FIG. 15A illustrates an example diagram showing architecture of the proposed CNN filter;

FIG. 15B illustrates an example diagram showing a construction of ResBlock (residual block) in the CNN filter;

FIG. 16A illustrates an example diagram showing architecture of the proposed CNN filter;

FIG. 16B illustrates an example diagram showing a construction of Attention Residual Block in FIG. 16A;

FIG. 17 illustrates a flowchart of a method for video processing in accordance with embodiments of the present disclosure; and

FIG. 18 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

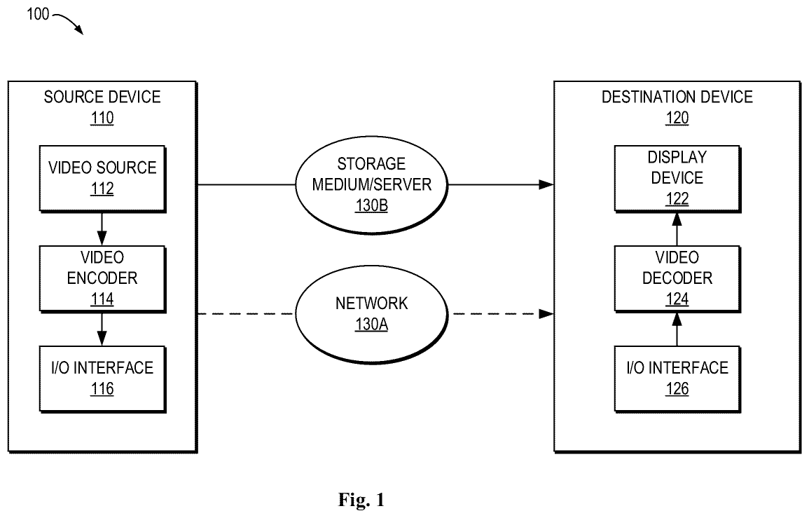

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

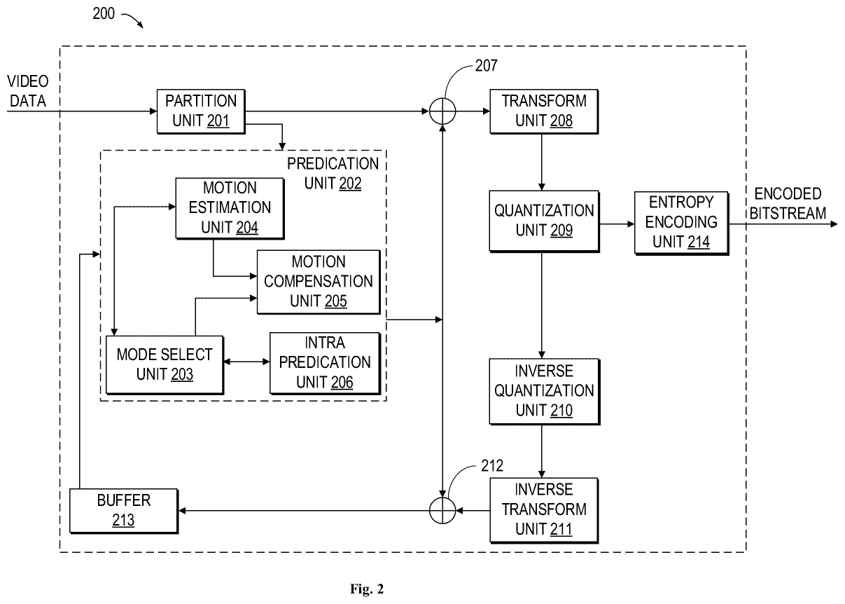

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is related to the loop filter in image/video coding. It may be applied to the existing video coding standard like High-Efficiency Video Coding (HEVC), Versatile Video Coding (VVC), or the standard (e.g., AVS3) to be finalized. It may be also applicable to future video coding standards or video codec or being used as post-processing method which is out of encoding/decoding process.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure where temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. VVC version 1 was finalized in July 2020.

The latest version of VVC draft, i.e., Versatile Video Coding (Draft 10) could be found at: http://phenix.it-sudparis.eu/jvet/doc_end_user/current_document.php?id=10399.

The latest reference software of VVC, named VTM, could be found at: https://vcgit.hhi.fraunhofer.de/jvet/VVCSoftware_VTM/-/tags/VTM-10.0.

### 2.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space. For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma subsampling. This scheme is sometimes used in high-end film scanners and cinematic post production.

2.1.2. 4:2:2

The two chroma components are sampled at half the sample rate of luma: the horizontal chroma resolution is halved. This reduces the bandwidth of an uncompressed video signal by one-third with little to no visual difference.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

### 2.2. Definitions of Video Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains a number of tiles of a picture or a number of bricks of a tile.

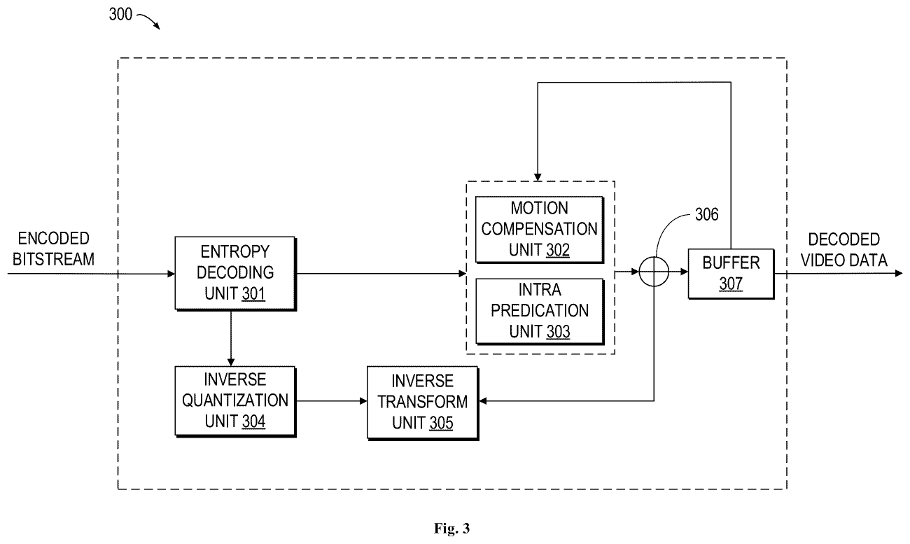

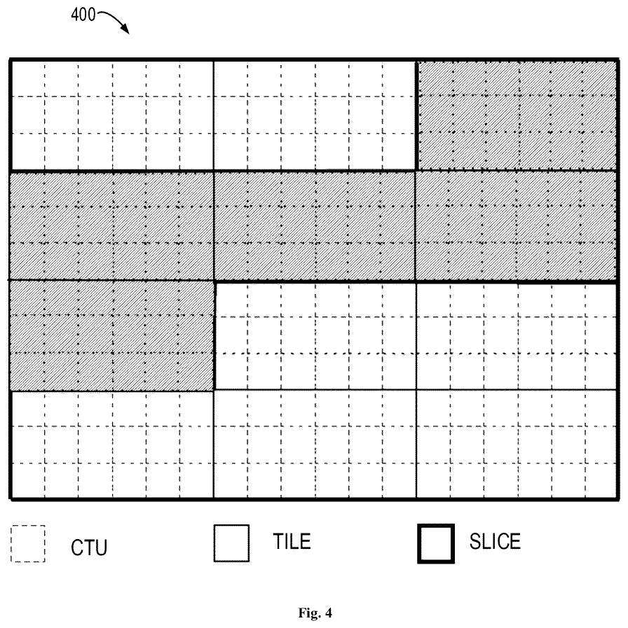

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice. FIG. 4 illustrates an example diagram 400 showing an example of raster-scan slice partitioning of a picture. In FIG. 4, the picture is divided into 12 tiles and 3 raster-scan slices. The picture in FIG. 4 with 18 by 12 luma CTUs is partitioned into 12 tiles and 3 raster-scan slices (informative).

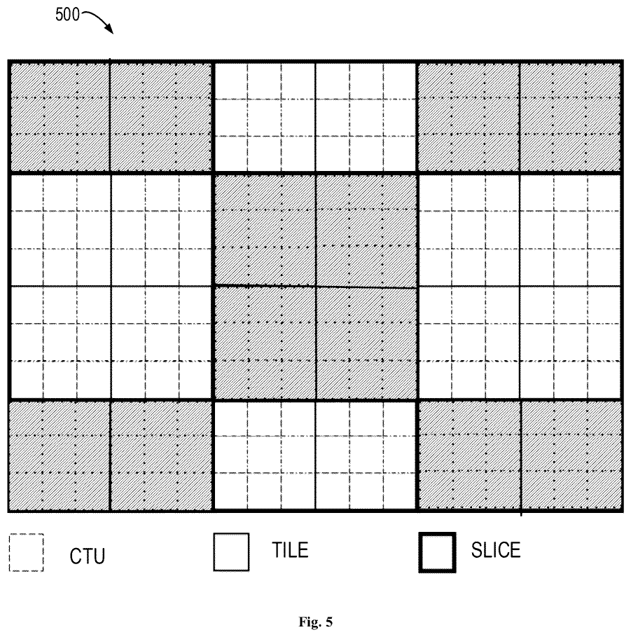

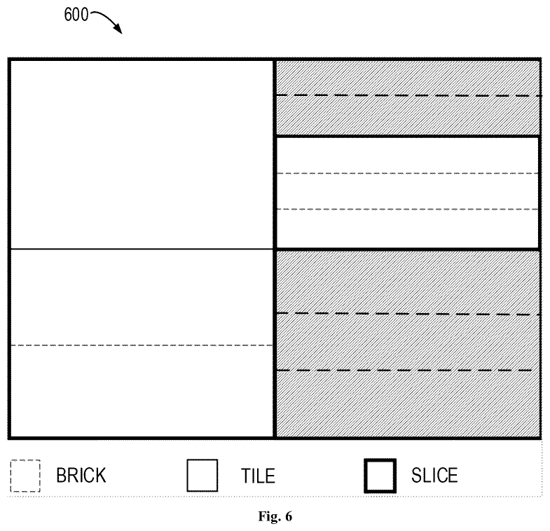

FIG. 5 illustrates an example diagram 500 showing an example of rectangular slice partitioning of a picture. In FIG. 5, the picture is divided into 24 tiles (6 tile columns and 4 tile rows) and 9 rectangular slices. The picture in FIG. 5 with 18 by 12 luma CTUs is partitioned into 24 tiles and 9 rectangular slices (informative). FIG. 6 illustrates an example diagram 600 showing an example of a picture partitioned into tiles, bricks, and rectangular slices. In FIG. 6, the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. The picture in FIG. 6 is partitioned into 4 tiles, 11 bricks, and 4 rectangular slices (informative).

### 2.2.1. CTU/CTB Sizes

In VVC, the CTU size, signaled in SPS by the syntax element log 2_ctu_size_minus2, could be as small as 4×4.

7.3.2.3 Sequence parameter set RBSP syntax

| | De- |
|---|---|
| | scrip- |
| | tor |
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < !rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma | |
| != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log 2_ctu_size_minus2 plus 2 specifies the luma coding tree block size of each CTU.

log_min_luma_coding_block_size_minus2 plus 2 specifies the minimum luma coding block size.

The variables CtbLog 2Size Y, CtbSizeY, MinCbLog 2SizeY, MinCbSize Y, MinTbLog 2Size Y, MaxTbLog 2SizeY, MinTbSizeY, MaxTbSize Y, PicWidthInCtbsY, PicHeightInCtbsY, PicSizeInCtbsY, PicWidthInMinCbsY, PicHeightInMinCbsY, PicSizeInMinCbsY, PicSizeInSamplesY, PicWidthInSamplesC and PicHeightInSamplesC are derived as follows:

$$Ctb Log 2 SizeY = log2\_ctu \_size \_minus2 + 2 \qquad ( 7 - 9 )$$

$$CtbSizeY = 1 ≪ Ctb Log 2 SizeY \qquad ( 7 - 10 )$$

$$Min Cb Log 2 SizeY = log2\_min \_luma \_coding \_block \_size \_minus2 + 2 \qquad ( 7 - 11 )$$

$$Min CbSizeY = 1 ≪ Min Cb Log 2 SizeY \qquad ( 7 - 12 )$$

$$Min Tb Log 2 SizeY = 2 \qquad ( 7 - 13 )$$

$$Max Tb Log 2 SizeY = 6 \qquad ( 7 - 14 )$$

$$Min TbSizeY = 1 ≪ Min Tb Log 2 SizeY \qquad ( 7 - 15 )$$

$$Max TbSizeY = 1 ≪ Max Tb Log 2 SizeY \qquad ( 7 - 16 )$$

$$PicWidthInCtbsY = Ceil ( pic\_width \_in \_luma \_samples \div CtbSizeY ) \qquad ( 7 - 17 )$$

$$PicHeightInCtbsY = Ceil ( pic\_height \_in \_luma \_samples \div CtbSizeY ) \qquad ( 7 - 18 )$$

$$PicSizeInCtbsY = PicWidthInCtbsY * PicHeightInCtbsY \qquad ( 7 - 19 )$$

$$PicWidthIn Min CbsY = pic\_width \_in \_luma \_samples / Min CbSizeY \qquad ( 7 - 20 )$$

$$PicHeightIn Min CbsY = pic\_height \_in \_luma \_samples / Min CbSizeY \qquad ( 7 - 21 )$$

$$PicSizeIn Min CbsY = PicWidthIn Min CbsY * PicHeightIn Min CbsY \qquad ( 7 - 22 )$$

$$PicSizeInSamplesY = pic\_width \_in \_luma \_samples * pic\_height \_in \_luma \_samples \qquad ( 7 - 23 )$$

$$PicWidthInSamplesC = pic\_width \_in \_luma \_samples / SubWidthC \qquad ( 7 - 24 )$$

$$PicHeightInSamplesC = pic\_height \_in \_luma \_samples / SubHeightC . \qquad ( 7 - 25 )$$

### 2.2.2. CTUs in a Picture

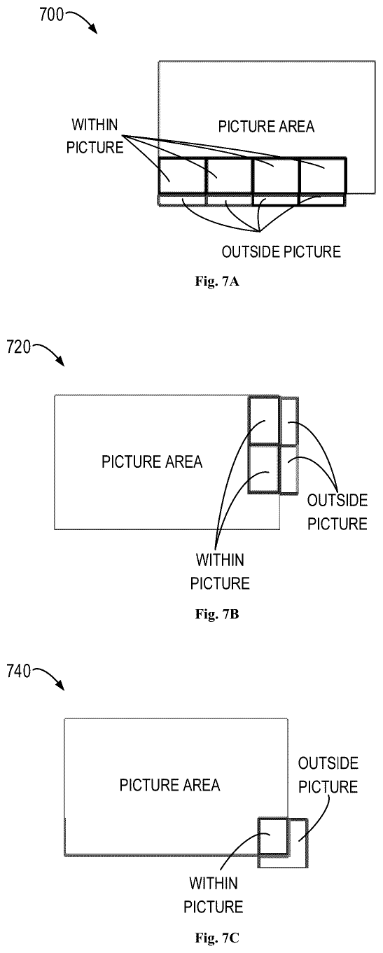

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border where either K<M or L<N. FIG. 7A illustrate an example diagram 700 showing CTBs crossing the bottom picture border, in which K=M, L<N. FIG. 7B illustrates an example diagram 720 showing CTBs crossing the right picture border, in which K<M, L=N. FIG. 7C illustrates an example diagram 740 showing CTBs crossing the right bottom picture border, in which K<M, L<N. For those CTBs as depicted in FIGS. 7A-7C, the CTB size is still equal to M×N, however, the bottom boundary/right boundary of the CTB is outside the picture.

### 2.3. Coding Flow of a Typical Video Codec

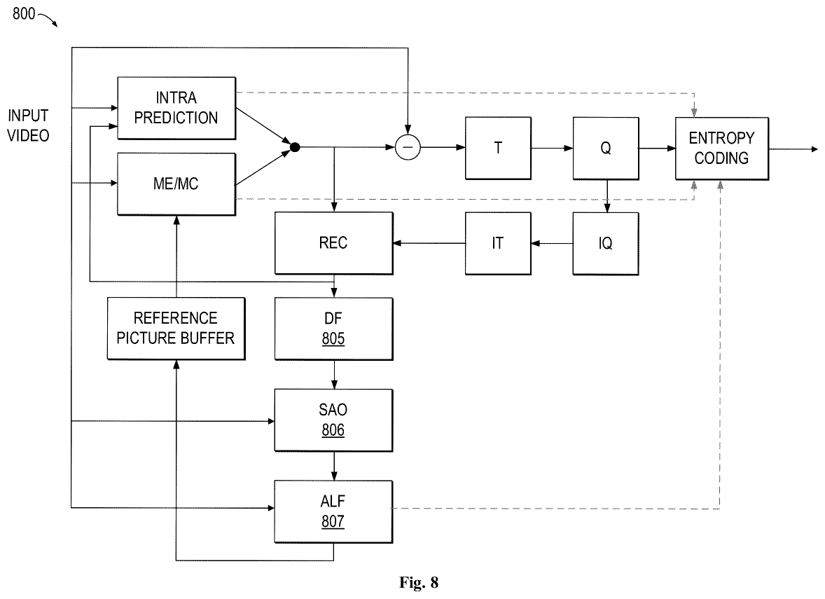

FIG. 8 illustrates an example diagram 800 showings an example of encoder block diagram of VVC, which contains three in-loop filtering blocks: deblocking filter (DF) 805, sample adaptive offset (SAO) 806 and ALF 807. Unlike DF 805, which uses predefined filters, SAO 806 and ALF 807 utilize the original samples of the current picture to reduce the mean square errors between the original samples and the reconstructed samples by adding an offset and by applying a finite impulse response (FIR) filter, respectively, with coded side information signaling the offsets and filter coefficients. ALF 807 is located at the last processing stage of each picture and can be regarded as a tool trying to catch and fix artifacts created by the previous stages.

### 2.4. Deblocking Filter (DB)

### The Input of DB is the Reconstructed Samples Before In-Loop Filters.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

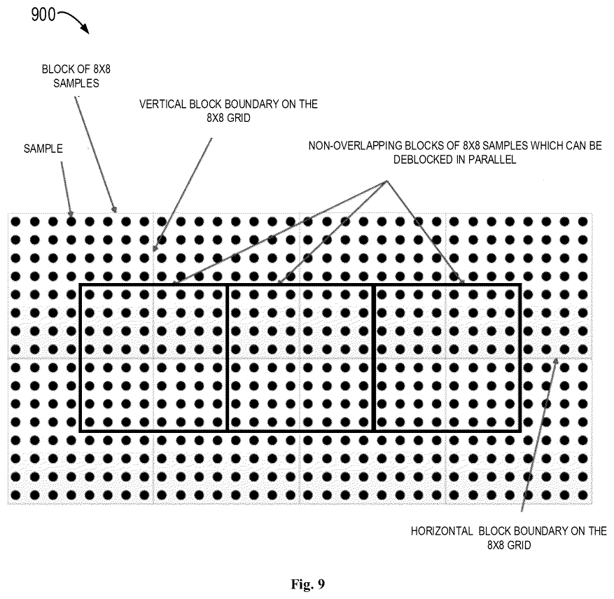

FIG. 9 illustrates an example diagram 900 showing an illustration of picture samples and horizontal and vertical block boundaries on the 8×8 grid, and the nonoverlapping blocks of the 8×8 samples, which can be deblocked in parallel.

### 2.4.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 2.4.2. Boundary Strength Calculation

For a transform block boundary/coding subblock boundary, if it is located in the 8×8 grid, it may be filtered and the setting of bS [xDᵢ][yDⱼ] (where [xDᵢ][yDⱼ] denotes the coordinate) for this edge is defined in Table 1 and Table 2, respectively.

TABLE 1
Boundary strength (when SPS IBC is disabled)

| Priority | Conditions | Y | U | V |
|---|---|---|---|---|
| 5 | At least one of the adjacent | 2 | 2 | 2 |
| | blocks is intra | | | |
| 4 | TU boundary and at least one of | 1 | 1 | 1 |
| | the adjacent blocks has non-zero | | | |
| | transform coefficients | | | |
| 3 | Reference pictures or number of | 1 | N/A | N/A |
| | MVs (1 for uni-prediction, 2 for bi- | | | |
| | prediction) of the adjacent | | | |
| | blocks are different | | | |
| 2 | Absolute difference between | 1 | N/A | N/A |
| | the motion vectors of same reference | | | |
| | picture that belong to the adjacent | | | |
| | blocks is greater than or equal to | | | |
| | one integer luma sample | | | |
| 1 | Otherwise | 0 | 0 | 0 |

TABLE 2
Boundary strength (when SPS IBC is enabled)

| Priority | Conditions | Y | U | V |
|---|---|---|---|---|
| 8 | At least one of the adjacent | 2 | 2 | 2 |
| | blocks is intra | | | |
| 7 | TU boundary and at least one of | 1 | 1 | 1 |
| | the adjacent blocks has non-zero | | | |
| | transform coefficients | | | |
| 6 | Prediction mode of adjacent blocks | 1 | | |
| | is different (e.g., one is IBC, one | | | |
| | is inter) | | | |
| 5 | Both IBC and absolute difference | 1 | N/A | N/A |
| | between the motion vectors that | | | |
| | belong to the adjacent blocks is | | | |
| | greater than or equal to one integer | | | |
| | luma sample | | | |
| 4 | Reference pictures or number of | 1 | N/A | N/A |
| | MVs (1 for uni-prediction, 2 for bi- | | | |
| | prediction) of the adjacent blocks | | | |
| | are different | | | |
| 3 | Absolute difference between the | 1 | N/A | N/A |
| | motion vectors of same reference | | | |
| | picture that belong to the adjacent | | | |
| | blocks is greater than or equal to | | | |
| | one integer luma sample | | | |
| 1 | Otherwise | 0 | 0 | 0 |

### 2.4.3. Deblocking Decision for Luma Component

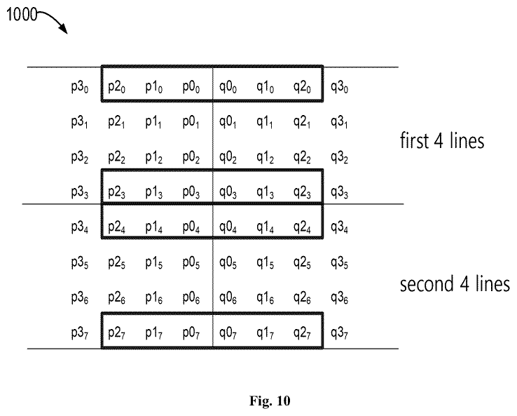

The deblocking decision process is described in this sub-section. FIG. 10 illustrates an example diagram 1000 showing pixels involved in filter on/off decision and strong/weak filter selection.

Wider-stronger luma filter is filters are used only if all the Condition1, Condition2 and Condition 3 are TRUE.

The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.

bSidePisLargeBlk=((edge type is vertical and p₀ belongs to CU with width>=32)∥(edge type is horizontal and p₀ belongs to CU with height>=32))?TRUE: FALSE

bSideQisLargeBlk=((edge type is vertical and q₀ belongs to CU with width >=32)∥(edge type is horizontal and q₀ belongs to CU with height≥=32))?TRUE: FALSE

Based on bSidePisLargeBlk and bSideQisLargeBlk, the condition 1 is defined as follows.

Condition1=(bSidePisLargeBlk∥bSidePisLargeBlk)?TRUE: FALSE

Next, if Condition 1 is true, the condition 2 will be further checked. First, the following variables are derived:

| | |
|---|---|
| - | dp0, dp3, dq0, dq3 are first derived as in HEVC |
| - | if (p side is greater than or equal to 32) |
| | dp0 = ( dp0 + Abs( p5₀ − 2 * p4₀ + p3₀ ) + 1 ) >> 1 |
| | dp3 = ( dp3 + Abs( p5₃ − 2 * p4₃ + p3₃ ) + 1 ) >> 1 |
| - | if (q side is greater than or equal to 32) |
| | dq0 = ( dq0 + Abs( q5₀ − 2 * q4₀ + q3₀ ) + 1 ) >> 1 |
| | dq3 = ( dq3 + Abs( q5₃ − 2 * q4₃ + q3₃ ) + 1 ) >> 1 |

Condition2 = (d < β) ? TRUE: FALSE
where d= dp0 + dq0 + dp3 + dq3.

If Condition1 and Condition2 are valid, whether any of the blocks uses sub-blocks is further checked:

```
If (bSidePisLargeBlk)
  {
    If (mode block P == SUBBLOCKMODE)
        Sp =5
      else
        Sp =7
}
else
Sp = 3
If (bSideQisLargeBlk)
  {
    If (mode block Q == SUBBLOCKMODE)
        Sq =5
      else
        Sq =7
    }
else
  Sq = 3
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
dpq is derived as in HEVC.
sp3 = Abs( p₃ − p₀ ), derived as in HEVC
if (p side is greater than or equal to 32)
    if(Sp==5)
      sp₃ = ( sp₃ + Abs( p₅ − p₃ ) + 1 ) >> 1
    else
      sp₃ =( sp₃ + Abs( p₇ − p₃ ) + 1) >> 1
sq₃ = Abs( q₀ − q₃ ), derived as in HEVC
if (q side is greater than or equal to 32)
  If(Sq==5)
    sq₃ = ( sq₃ + Abs( q₅ − q₃ ) + 1) >> 1
  else
    sq₃ = ( sq₃ + Abs( q₇ − q₃ ) + 1) >> 1
```

As in HEVC, StrongFilterCondition=(dpq is less than (β>>2), sp₃+sq₃ is less than (3*β>>5), and Abs(p₀−q₀) is less than (5*t_{C}+1)>>1)? TRUE: FALSE.

### 2.4.4. Stronger Deblocking Filter for Luma (Designed for Larger Blocks)

Bilinear filter is used when samples at either one side of a boundary belong to a large block. A sample belonging to a large block is defined as when the width >=32 for a vertical edge, and when height >=32 for a horizontal edge.

The bilinear filter is listed below.

Block boundary samples pi for i=0 to Sp-1 and qᵢ for j=0 to Sq-1 (pi and qi are the i-th sample within a row for filtering vertical edge, or the i-th sample within a column for filtering horizontal edge) in HEVC deblocking described above) are then replaced by linear interpolation as follows:

$${p}_{i}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i} \\ {q}_{j}^{′} = ( {g}_{j} * {Middle}_{s , t} + ( 64 - {g}_{j} ) * {Q}_{s} + 32 ) ≫ 6 ) , clipped to {q}_{j} \pm {tcPD}_{j}$$

where tcPDᵢ and tcPDᵢ term is a position dependent clipping described in Section 2.4.7 and gⱼ, fᵢ, Middle_{s,t}, Pₛ and Qₛ are given below.

### 2.4.5. Deblocking Control for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped.

Chroma deblocking is performed when bS is equal to 2, or bS is equal to 1 when a large block boundary is detected.

The second and third condition is basically the same as HEVC luma strong filter decision as follows.

In the second condition:
d is then derived as in HEVC luma deblocking.
The second condition will be TRUE when d is less than β.

In the third condition StrongFilterCondition is derived as follows:
dpq is derived as in HEVC.
sp₃=Abs(p₃−p₀), derived as in HEVC.
sq₃=Abs(q₀−q₃), derived as in HEVC.

As in HEVC design, StrongFilterCondition=(dpq is less than (β>>2), sp₃+sq₃ is less than (β>>3), and Abs(p₀−q₀) is less than (5*t_{C}+1)>>1).

### 2.4.6. Strong Deblocking Filter for Chroma

The following strong deblocking filter for chroma is defined:

$${p}_{2}^{′} = ( 3 * {p}_{3} + 2 * {p}_{2} + {p}_{1} + {p}_{0} + {q}_{0} + 4 ) ≫ 3 \\ {p}_{1}^{′} = ( 2 * {p}_{3} + {p}_{2} + 2 * {p}_{1} + {p}_{0} + {q}_{0} + {q}_{1} + 4 ) ≫ 3 \\ {p}_{0}^{′} = ( {p}_{3} + {p}_{2} + {p}_{1} + 2 * {p}_{0} + {q}_{0} + {q}_{1} + {q}_{2} + 4 ) ≫ 3.$$

The proposed chroma filter performs deblocking on a 4×4 chroma sample grid.

### 2.4.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making process in section 2.4.2, position dependent threshold table is selected from two tables (i.e., Tc7 and Tc3 tabulated below) that are provided to decoder as a side information:

Tc7 = { 6, 5, 4, 3, 2, 1, 1}; Tc3 = { 6, 4, 2 };
tcPD = (Sp == 3) ? Tc3 : Tc7;
tcQD = (Sq == 3) ? Tc3 : Tc7;

For the P or Q boundaries being filtered with a short symmetrical filter, position dependent threshold of lower magnitude is applied:

### Tc3={3, 2, 1};

Following defining the threshold, filtered p′ᵢ and q′ᵢ sample values are clipped according to tcP and tcQ clipping values:

$${p}_{i}^{″} = Clip 3 ( {p}_{i}^{′} + {tcP}_{i} , {p}_{i}^{′} - {tcP}_{i} , {p}_{i}^{′} ) ; \\ {q}_{j}^{″} = Clip 3 ( {q}_{j}^{′} + {tcQ}_{j} , {q}_{j}^{″} - {tcQ}_{j} , {q}_{j}^{′} ) ;$$

where p′ᵢ and q′ᵢ are filtered sample values, p″ᵢ and q″ᵢ are output sample value after the clipping and tcPᵢ tcPᵢ are clipping thresholds that are derived from the VVC tc parameter and tcPD and tcQD. The function Clip3 is a clipping function as it is specified in VVC.

### 2.4.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Additionally, the sub-block deblocking is adjusted such that that sub-block boundaries on an 8×8 grid that are close to a CU or an implicit TU boundary is restricted to modify at most two samples on each side.

Following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 ∥ edge == (orthogonalLength − 2) ∥ edge == (56 / 4) ∥
    edge == (72 / 4))
      Sp = Sq = 2;
    else
      Sp = Sq = 3;
  else
    Sp = Sq = bSideQisLargeBlk ? 5:3
}
```

Where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 2.5. SAO

The input of SAO is the reconstructed samples after DB. The concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC and VVC, the region (the unit for SAO parameters signaling) is defined to be a CTU.

Two SAO types that can satisfy the requirements of low complexity are adopted in HEVC. Those two types are edge offset (EO) and band offset (BO), which are discussed in further detail below. An index of an SAO type is coded (which is in the range of [0, 2]). For EO, the sample classification is based on comparison between current samples and neighboring samples according to 1-D directional patterns: horizontal, vertical, 135° diagonal, and 45° diagonal.

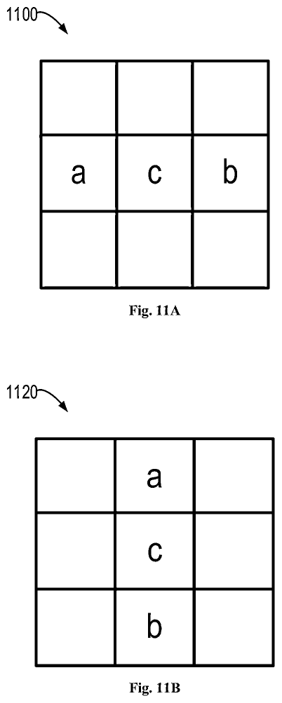

FIG. 11A illustrates an example diagram 1100 showing a 1-D directional pattern for EO sample classification with horizontal (EO class=0). FIG. 11B illustrates an example diagram 1120 showing a 1-D directional pattern for EO sample classification with vertical (EO class=1). FIG. 11C illustrates an example diagram 1140 showing a 1-D directional pattern for EO sample classification with 135° diagonal (EO class=2). FIG. 11D illustrates an example diagram 1160 showing a 1-D directional pattern for EO sample classification with 45° diagonal (EO class=3).

For a given EO class, each sample inside the CTB is classified into one of five categories. The current sample value, labeled as “c,” is compared with its two neighbors along the selected 1-D pattern. The classification rules for each sample are summarized in Table 1. Categories 1 and 4 are associated with a local valley and a local peak along the selected 1-D pattern, respectively. Categories 2 and 3 are associated with concave and convex corners along the selected 1-D pattern, respectively. If the current sample does not belong to EO categories 1-4, then it is category 0 and SAO is not applied.

TABLE 3
Sample Classification Rules for Edge Offset

| Category | Condition |
|---|---|
| 1 | c < a and c < b |
| 2 | ( c < a && c == b) \|\| (c == a && c < b) |
| 3 | ( c > a && c == b) \|\| (c == a && c > b) |
| 4 | c> a && c > b |
| 5 | None of above |

### 2.6. Geometry Transformation-Based Adaptive Loop Filter in JEM

The input of DB is the reconstructed samples after DB and SAO. The sample classification and filtering process are based on the reconstructed samples after DB and SAO.

In the JEM, a geometry transformation-based adaptive loop filter (GALF) with block-based filter adaption is applied. For the luma component, one among 25 filters is selected for each 2×2 block, based on the direction and activity of local gradients.

### 2.6.1. Filter Shape

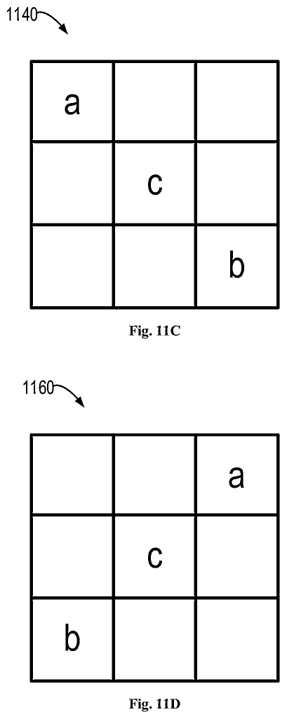

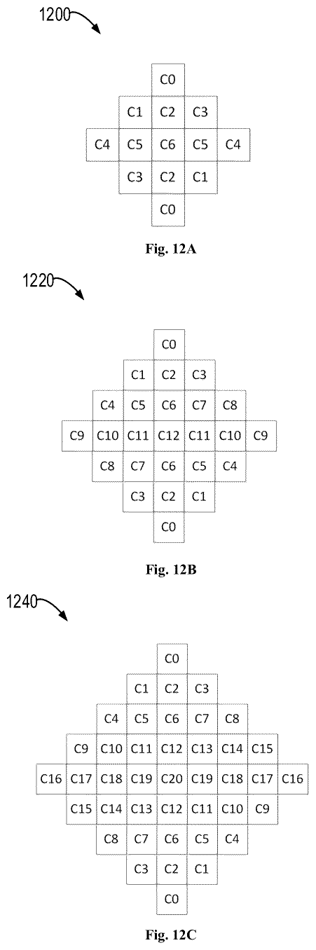

FIG. 12A illustrates an example diagram 1200 showing examples of GALF filter shapes with 5×5 diamond. FIG. 12B illustrates an example diagram 1220 showing examples of GALF filter shapes with 7×7 diamond. FIG. 12C illustrates an example diagram 1240 showing examples of GALF filter shapes with 9×9 diamond.

In the JEM, up to three diamond filter shapes (as shown in FIGS. 12A-12C) can be selected for the luma component. An index is signalled at the picture level to indicate the filter shape used for the luma component. Each square represents a sample, and Ci (i being 0˜6 (left), 0˜12 (middle), 0˜20 (right)) denotes the coefficient to be applied to the sample. For chroma components in a picture, the 5×5 diamond shape is always used.

### 2.6.1.1. Block Classification

Each 2×2 block is categorized into one out of 25 classes. The classification index C is derived based on its directionality D and a quantized value of activity Â, as follows:

$$C = 5 D + \hat{A} . \qquad ( 1 )$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert , \qquad ( 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert , \qquad ( 3 )$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \qquad ( 4 )$$

$${g}_{d 2} = {\sum }_{k = i - 2}^{i + 3} {\sum }_{l = j - 2}^{j + 3} D {2}_{k , l} , D {2}_{k , l} = \vert 2 R ( k , l ) - R ( k - 1 , l + 1 ) - R ( k + 1 , l - 1 ) \vert \qquad ( 5 )$$

Indices i and j refer to the coordinates of the upper left sample in the 2×2 block and R(i,j) indicates a reconstructed sample at coordinate (i,j).

Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) , \qquad ( 6 )$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) , \qquad ( 7 )$$

To derive the value of the directionality D, these values are compared against each other and with two thresholds t₁ and t₂:
Step 1. If both g_{h,v}^{max}≤t₁·g_{h,v}^{min} and g_{d0,d1}^{max}≤t₁·g_{d0,d1}^{min} are true, D is set to 0.
Step 2. If g_{h,v}^{max}/g_{h,v}^{min}>g_{d0,d1}^{max}/g_{d0,d1}^{min}, continue from Step 3; otherwise continue from Step 4.
Step 3. If g_{h,v}^{max}>t₂·g_{h,v}^{min}, D is set to 2; otherwise D is set to 1.
Step 4. If g_{d0,d1}^{max}>t₂·g_{d0,d1}^{min}, D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) . \qquad ( 8 )$$

A is further quantized to the range of 0 to 4, inclusively, and the quantized value is denoted as Â.

For both chroma components in a picture, no classification method is applied, i.e. a single set of ALF coefficients is applied for each chroma component.

### 2.6.1.2. Geometric Transformations of Filter Coefficients

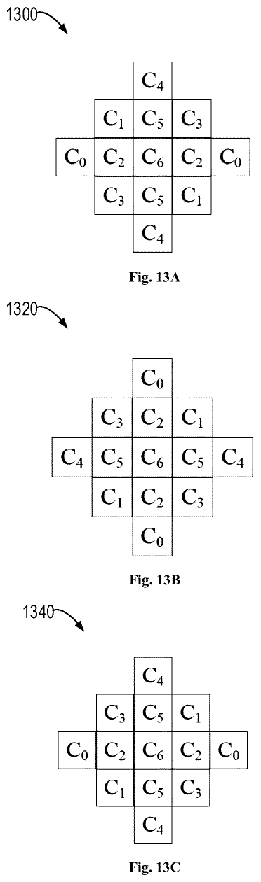

FIG. 13A illustrates an example diagram 1300 showing relative coordinator for the 5×5 diamond filter support (diagonal). FIG. 13B illustrates an example diagram 1320 showing relative coordinator for the 5×5 diamond filter support (vertical flip). FIG. 13C illustrates an example diagram 1340 showing relative coordinator for the 5×5 diamond filter support (rotation).

Before filtering each 2×2 block, geometric transformations such as rotation or diagonal and vertical flipping are applied to the filter coefficients f(k, l), which is associated with the coordinate (k, l), depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$\begin{matrix}Diagonal : {f}_{D} ( k , l ) = f ( l , k ) , \\ Vertical flip : {f}_{V} ( k , l ) = f ( k , K - l - 1 ) , \\ Rotation : {f}_{R} ( k , l ) = f ( K - l - 1 , k ) .\end{matrix} \qquad ( 9 )$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k, l) depending on gradient values calculated for that block. The relationship between the transformation and the four gradients of the four directions are summarized in Table 4. FIGS. 12A-12C show the transformed coefficients for each position based on the 5×5 diamond.

TABLE 4
Mapping of the gradient calculated for one
block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.6.1.3. Filter Parameters Signalling

In the JEM, GALF filter parameters are signalled for the first CTU, i.e., after the slice header and before the SAO parameters of the first CTU. Up to 25 sets of luma filter coefficients could be signalled. To reduce bits overhead, filter coefficients of different classification can be merged. Also, the GALF coefficients of reference pictures are stored and allowed to be reused as GALF coefficients of a current picture. The current picture may choose to use GALF coefficients stored for the reference pictures and bypass the GALF coefficients signalling. In this case, only an index to one of the reference pictures is signalled, and the stored GALF coefficients of the indicated reference picture are inherited for the current picture.

To support GALF temporal prediction, a candidate list of GALF filter sets is maintained. At the beginning of decoding a new sequence, the candidate list is empty. After decoding one picture, the corresponding set of filters may be added to the candidate list. Once the size of the candidate list reaches the maximum allowed value (i.e., 6 in current JEM), a new set of filters overwrites the oldest set in decoding order, and that is, first-in-first-out (FIFO) rule is applied to update the candidate list. To avoid duplications, a set could only be added to the list when the corresponding picture doesn't use GALF temporal prediction. To support temporal scalability, there are multiple candidate lists of filter sets, and each candidate list is associated with a temporal layer. More specifically, each array assigned by temporal layer index (TempIdx) may compose filter sets of previously decoded pictures with equal to lower TempIdx. For example, the k-th array is assigned to be associated with TempIdx equal to k, and it only contains filter sets from pictures with TempIdx smaller than or equal to k. After coding a certain picture, the filter sets associated with the picture will be used to update those arrays associated with equal or higher TempIdx.

Temporal prediction of GALF coefficients is used for inter coded frames to minimize signalling overhead. For intra frames, temporal prediction is not available, and a set of 16 fixed filters is assigned to each class. To indicate the usage of the fixed filter, a flag for each class is signalled and if required, the index of the chosen fixed filter. Even when the fixed filter is selected for a given class, the coefficients of the adaptive filter f(k, l) can still be sent for this class in which case the coefficients of the filter which will be applied to the reconstructed image are sum of both sets of coefficients.

The filtering process of luma component can controlled at CU level. A flag is signalled to indicate whether GALF is applied to the luma component of a CU. For chroma component, whether GALF is applied or not is indicated at picture level only.

### 2.6.1.4. Filtering Process

At decoder side, when GALF is enabled for a block, each sample R(i, j) within the block is filtered, resulting in sample value R′(i, j) as shown below, where L denotes filter length, f_{m,n} represents filter coefficient, and f(k, l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l ) \qquad ( 10 )$$

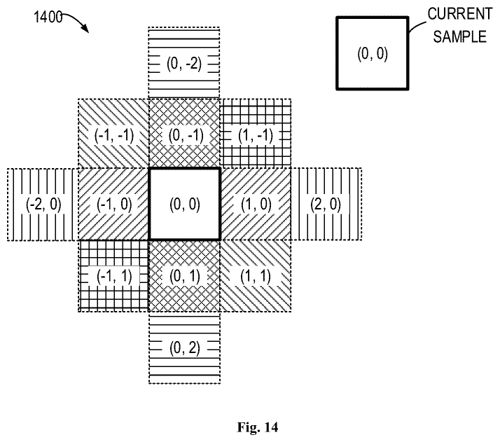

FIG. 14 illustrates an example diagram 1400 showing examples of relative coordinates for the 5×5 diamond filter support. FIG. 14 shows an example of relative coordinates used for 5×5 diamond filter support supposing the current sample's coordinate (i, j) to be (0, 0). Samples in different coordinates filled with the same color are multiplied with the same filter coefficients.

### 2.7. Geometry Transformation-Based Adaptive Loop Filter (GALF) in VVC

### 2.7.1. GALF in VTM-4

In VTM4.0, the filtering process of the Adaptive Loop Filter, is performed as follows:

$$O ( x , y ) = {\sum }_{( i , j )} w ( i , j ) . I ( x + i , y + j ) , \qquad ( 11 )$$

where samples I(x+i, y+j) are input samples, O(x, y) is the filtered output sample (i.e. filter result), and w(i, j) denotes the filter coefficients. In practice, in VTM4.0 it is implemented using integer arithmetic for fixed point precision computations:

$$O ( x , y ) = ( {\sum }_{i = - \frac{L}{2}}^{\frac{L}{2}} {\sum }_{j = - \frac{L}{2}}^{\frac{L}{2}} w ( i , j ) . I ( x + i , y + j ) + 64 ) ≫ 7 , \qquad ( 12 )$$

where L denotes the filter length, and where w(i, j) are the filter coefficients in fixed point precision.

The current design of GALF in VVC has the following major changes compared to that in JEM:
1) The adaptive filter shape is removed. Only 7×7 filter shape is allowed for luma component and 5×5 filter shape is allowed for chroma component.
2) Signaling of ALF parameters in removed from slice/picture level to CTU level.
3) Calculation of class index is performed in 4×4 level instead of 2×2. In addition, sub-sampled Laplacian calculation method for ALF classification is utilized. More specifically, there is no need to calculate the horizontal/vertical/45 diagonal/135 degree gradients for each sample within one block. Instead, 1:2 subsampling is utilized.

### 2.8. Non-Linear ALF in Current VVC

### 2.8.1. Filtering Reformulation

Equation (11) can be reformulated, without coding efficiency impact, in the following expression:

$$O ( x , y ) = I ( x , y ) + {\sum }_{( i , j ) \neq ( 0 , 0 )} w ( i , j ) . ( I ( x + i , y + j ) - I ( x , y ) ) , \qquad ( 13 )$$

where w(i, j) are the same filter coefficients as in equation (11) [excepted w(0, 0) which is equal to 1 in equation (13) while it is equal to 1−Σ_{(i,j)≠(0,0)} w(i, j) in equation (11)].

Using this above filter formula of (13), VVC introduces the non-linearity to make ALF more efficient by using a simple clipping function to reduce the impact of neighbor sample values (I(x+i, y+j)) when they are too different with the current sample value (I(x, y)) being filtered.

More specifically, the ALF filter is modified as follows:

$${O}^{′} ( x , y ) = I ( x , y ) + {\sum }_{( i , j ) \neq ( 0 , 0 )} w ( i , j ) . K ( I ( x + i , y + j ) - I ( x , y ) , k ( i , j ) ) , \qquad ( 14 )$$

where K(d, b)=min(b, max(−b, d)) is the clipping function, and k(i, j) are clipping parameters, which depends on the (i, j) filter coefficient. The encoder performs the optimization to find the best k(i, j). In some implementation, the clipping parameters k(i, j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The sets of clipping values are provided in the Table 5. The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 ¨ N ] \} , with M = {2}^{10} and N = 4 . \qquad ( 15 )$$

Similarly, the Chroma tables of clipping values is obtained according to the following formula:

$${AlfClip}_{C} = \{ round ( A . {( {( \frac{M}{A} )}^{\frac{1}{N - 1}} )}^{N - n} ) for n ∈ 1 ¨ N ] \} , with M = {2}^{10} , N = 4 and A = 4. \qquad ( 16 )$$

TABLE 5
Authorized clipping values

| | INTRA/INTER tile group |
|---|---|
| LUMA | { 1024, 181, 32, 6 } |
| CHROMA | { 1024, 161, 25, 4 } |

The selected clipping values are coded in the “alf_data” syntax element by using a Golomb encoding scheme corresponding to the index of the clipping value in the above Table 5. This encoding scheme is the same as the encoding scheme for the filter index.

### 2.9. Convolutional Neural Network-Based Loop Filters for Video Coding

### 2.9.1. Convolutional Neural Networks

In deep learning, a convolutional neural network (CNN, or ConvNet) is a class of deep neural networks, most commonly applied to analyzing visual imagery. They have very successful applications in image and video recognition/processing, recommender systems, image classification, medical image analysis, natural language processing.

CNNs are regularized versions of multilayer perceptrons. Multilayer perceptrons usually mean fully connected networks, that is, each neuron in one layer is connected to all neurons in the next layer. The “fully-connectedness” of these networks makes them prone to overfitting data. Typical ways of regularization include adding some form of magnitude measurement of weights to the loss function. CNNs take a different approach towards regularization: they take advantage of the hierarchical pattern in data and assemble more complex patterns using smaller and simpler patterns. Therefore, on the scale of connectedness and complexity, CNNs are on the lower extreme.

CNNs use relatively little pre-processing compared to other image classification/processing algorithms. This means that the network learns the filters that in traditional algorithms were hand-engineered. This independence from prior knowledge and human effort in feature design is a major advantage.

### 2.9.2. Deep Learning for Image/Video Coding

Deep learning-based image/video compression typically has two implications: end-to-end compression purely based on neural networks and traditional frameworks enhanced by neural networks. The first type usually takes an auto-encoder like structure, either achieved by convolutional neural networks or recurrent neural networks. While purely relying on neural networks for image/video compression can avoid any manual optimizations or hand-crafted designs, compression efficiency may be not satisfactory. Therefore, works distributed in the second type take neural networks as an auxiliary, and enhance traditional compression frameworks by replacing or enhancing some modules. In this way, they can inherit the merits of the highly optimized traditional frameworks. For example, a fully connected network for the intra prediction is proposed. In addition to intra prediction, deep learning is also exploited to enhance other modules. For example, the in-loop filters of HEVC with a convolutional neural network is replaced and promising results are achieved. Neural networks are applied to improve the arithmetic coding engine.

### 2.9.3. Convolutional Neural Network Based In-Loop Filtering

In lossy image/video compression, the reconstructed frame is an approximation of the original frame, since the quantization process is not invertible and thus incurs distortion to the reconstructed frame. To alleviate such distortion, a convolutional neural network could be trained to learn the mapping from the distorted frame to the original frame. In practice, training must be performed prior to deploying the CNN-based in-loop filtering.

### 2.9.3.1. Training

The purpose of the training processing is to find the optimal value of parameters including weights and bias.

First, a codec (e.g. HM, JEM, VTM, etc.) is used to compress the training dataset to generate the distorted reconstruction frames.

Then the reconstructed frames are fed into the CNN and the cost is calculated using the output of CNN and the groundtruth frames (original frames). Commonly used cost functions include SAD (Sum of Absolution Difference) and MSE (Mean Square Error). Next, the gradient of the cost with respect to each parameter is derived through the back propagation algorithm. With the gradients, the values of the parameters can be updated. The above process repeats until the convergence criteria is met. After completing the training, the derived optimal parameters are saved for use in the inference stage.

### 2.9.3.2. Convolution Process

During convolution, the filter is moved across the image from left to right, top to bottom, with a one-pixel column change on the horizontal movements, then a one-pixel row change on the vertical movements. The amount of movement between applications of the filter to the input image is referred to as the stride, and it is almost always symmetrical in height and width dimensions. The default stride or strides in two dimensions is (1,1) for the height and the width movement.

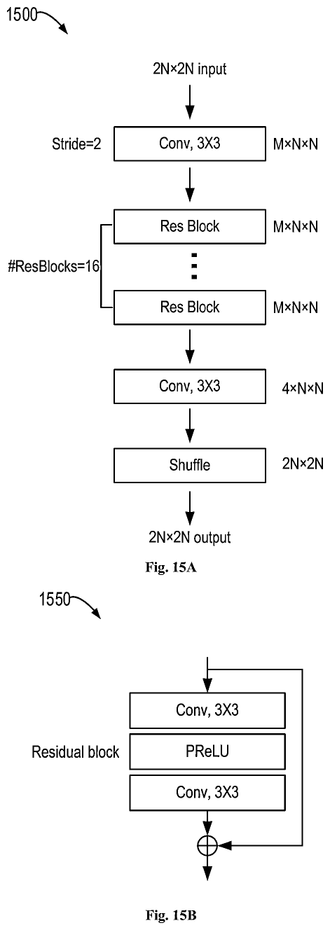

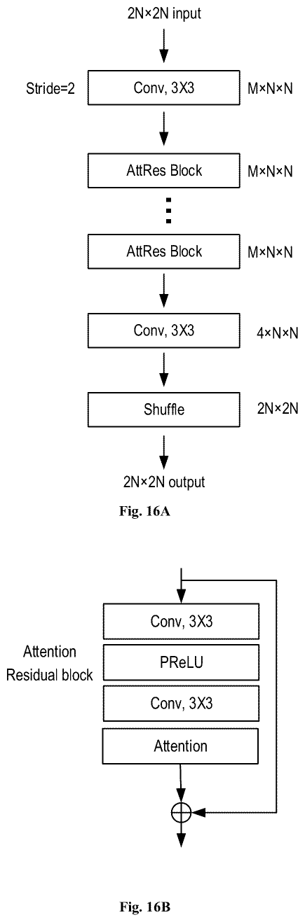

FIG. 15A illustrates an example diagram 1500 showing Architecture of the proposed CNN filter. FIG. 15B illustrates an example diagram 1550 showing a construction of ResBlock (residual block) in the CNN filter. In most of deep convolutional neural networks, residual blocks are utilized as the basic module and stacked several times to construct the final network where in one example, the residual block is obtained by combining a convolutional layer, a ReLU/PRELU activation function and a convolutional layer as shown in FIG. 15B.

### 2.9.3.3. Inference

During the inference stage, the distorted reconstruction frames are fed into CNN and processed by the CNN model whose parameters are already determined in the training stage. The input samples to the CNN can be reconstructed samples before or after DB, or reconstructed samples before or after SAO, or reconstructed samples before or after ALF.

### 3. Problems

The current NN filter has the following problems:
1. The prior art design of NN filter is only applied after the reconstruction of all blocks before in-loop filtering processes within a slice. Therefore, the impact of reduced distortion due to NN filter is not taken into consideration during the rate-distortion optimization (RDO) process, such as intra mode selection, partitioning selection, intra mode selection, inter mode selection, transform core selection, etc. The coding performance is sub-optimal considering:
   a. The best mode (e.g., coding method/partitioning sizes) of current block selected in the RDO process could be wrong since the distortion is calculated without NN filter being applied.
   b. The reconstruction and associated coded information of current block has big impact on coding of the subsequent blocks (e.g., due to intra prediction, or motion prediction). If the current block doesn't select the best mode, then the coding performance of sub-sequence block will also be sub-optimal.

### 4. Description

The detailed embodiments below should be considered as examples to explain general concepts. These embodiments should not be interpreted in a narrow way. Furthermore, these embodiments can be combined in any manner.

To solve the above problem, it is proposed to take the NN filter into consideration based on video content during the rate distortion optimization (RDO) process. The present disclosure elaborates how to extend RDO purview with NN filter models, how to utilize NN filter models to select mode (e.g. intra mode, partitioning mode, inter mode or transform core), how to control the usage of NN filter models.

In the disclosure, a NN filter can be any kind of NN filter, such as a convolutional neural network (CNN) filter; alternatively, it could also be applied to non-NN based filters. In the following discussion, a NN filter may also be referred to as a CNN filter.

In the following discussion, a video unit may be a sequence, a picture, a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick. A father video unit represents a unit larger than the video unit. Typically, a father unit will contain several video units. E.g., when the video unit is CTU, the father unit could be slice, CTU row, multiple CTUs, etc.

The width and height of a video unit are denoted as W and H, respectively.

### On Utilization of the NN Filter Models to Select the Modes in the RDO Process

1. Whether to and/or how to utilize the NN filter models (or calculate the rate distortion cost) in RDO process may be dependent on the distortion D_{ORG} without NN filter model and/or the distortion Dⁿ_{NNLF} with n^{th} NN filter model (the model index is n−1, where n>=1). The RDO criterion is noted as J=D+lambda*R. “A distortion Dⁿ_{NNLF} with the n^{th} NN filter” may mean that the reconstruction samples are filtered by the n^{th} NN filter and the filtered reconstruction samples will be compared with the original samples to derive the distortion.
   a. In one example, D in RDO criterion is the distortion with the n^{th} NN filter model, D=Dⁿ_{NNLF}.
      i. In one example, n is 1, 2, 3.
   b. In one example, D in RDO criterion is the minimal value of the distortion without NN filter model and distortion with the n^{th} NN filter model. D=min (Dⁿ_{NNLF}. D_{ORG}).
      i. In one example, n is 1, 2, 3.
   c. In one example, D in RDO criterion is the distortion with the best one of NN filter models.
      i. In one example, the best NN filter model is selected by distortion.
      ii. In one example, the best NN filter model is default one.
   d. In one example, D in RDO criterion is the minimal value of distortion without NN filter model and the distortion with the best one of NN filter models.
      i. In one example, the best NN filter model is selected by distortion.
      ii. In one example, the best NN filter model is default one.
   e. In one example, D in RDO criterion is a scaled version of the distortion without NN filter model, i.e.D=f*D_{ORG}.
      i. In one example, f is 1.0, 0.9, or 1.1.
   f. In one example, D in RDO criterion is derived according to the distortion without NN filter model and the distortion with the n^{th} NN filter model.
      i. In one example, D=f₀*D_{ORG}+f₁*Dⁿ_{NNLF}.
         1) In one example, f₀=0.0, f₁=1.0;
         2) In one example, f₀=1.0, f₁=0.0.
      ii. In one example, D=min (f₀*D_{ORG}, f₁*Dⁿ_{NNLF}).
         1) In one example, f₀=1.0, f₁=1.0.
   g. In one example, D in RDO criterion may be the combination of multiple calculating methods in the above embodiments.
      i. In one example, the combination of calculating methods may be dependent on the coding statistics of the video unit (e.g., prediction modes, qp, temporal layer, slice type, etc.).
         1) In one example, the combination of calculating methods may be dependent on the type of candidate modes.
         2) In one example, when all or one of T candidate modes are NOT partitioning modes, D in RDO criterion is combination of the distortion with the p^{th} NN filter model and/or distortion without NN filter model.
         a. In one example, when the p^{th} NN filter model is NOT applied for one or all of T candidate modes, D in RDO criterion is the distortion without NN filter model (D=D_{ORG}).
         b. In one example, when the p^{th} NN filter model is applied for all or one of T candidate modes, D in RDO criterion is the distortion with the p^{th} NN filter model (D=D^{p}_{NNLF}).
         3) In one example, when all or one of T candidate modes are partitioning modes, D in RDO criterion is combination of the distortion with the q^{th} NN filter model and/or the distortion with the p^{th} NN filter model and/or distortion without NN filter model.
      ii. In one example, the combination may be dependent on the usage of the q^{th} NN filter model and/or the usage of the p^{th} NN filter model.
         1) In one example, when the q^{th} NN filter model is applied for all or one of T candidate modes, D in RDO criterion is the minimal value of the distortion without NN filter model and distortion with the q^{th} NN filter model (D=min (D^{q}_{NNLF}, D_{ORG})).
         2) In one example, when the q^{th} NN filter model is NOT applied for one or all of T candidate modes, D in RDO criterion is combination of the distortion with the p^{th} NN filter model and distortion without NN filter model.
         a. In one example, when the p^{th} NN filter model is applied for all of T candidate modes, D in RDO criterion is the distortion with the p^{th} NN filter model (D=D^{p}_{NNLF}).
         b. In one example, when the p^{th} NN filter model is NOT applied for one or all of T candidate modes, D in RDO criterion is the distortion without NN filter model (D=D_{ORG}).
      iii. In one example, the methods of calculating the D in RDO criterion may be applied according to the certain or adaptive order.
         1) In one example, the order of applying the methods of calculating the D in RDO criterion may be dependent on the coding modes/statistics of the video unit (e.g., prediction modes, qp, temporal layer, slice type, etc.).
         2) In one example, D=min (D^{q}_{NNLF}, D_{ORG}) may have a greater priority than D=D^{p}_{NNLF}.
         3) In one example, D=D^{p}_{NNLF} may have a greater priority than D=D_{ORG}.
      iv. In the above embodiments, the p^{th} NN filter model may be the deblocking filter or SAO or ALF.
      v. In the above embodiments, the q^{th} NN filter model may be the CNN filter.
      vi. In the above embodiments, the q^{th} NN filter model may be same with the p^{th} NN filter model.
         1) In one example, p may be equal to q.
      vii. In the above embodiments, T candidate modes may be the comparable modes with the RDO criterion noted as J=D+lambda*R.
         1) In one example, the number T of candidate modes may be equal to 1 or 2 or 3 or 4.
   h. In the above embodiments, the parameters f or f₀ or f₁ may be set according to the temporal layers and/or slice types.
   i. In the above embodiments, the parameters f or f₀ or f₁ may be set according to the QP (quantization parameter).
   j. In the above embodiments, the parameters f or f₀ or f₁ may be set according to the configuration (e.g., all intra, random access, low-delay B, low-delay P, etc.).
   k. In one example, the same rule of usage of NN filtering should be applied to calculate RD costs for all candidate modes and/or partitioning methods for a block.
2. Whether to and/or how to utilize the NN filter models (or calculate the rate distortion cost) in RDO process may be dependent on the distortion D_{ORG} without NN filter model and/or the combination of distortions with multiple NN filter models. The RDO criterion is noted as J=D+lambda*R.
   a. In one example, D in RDO criterion is the minimal value of distortions with m NN filter models.
      i. In one example, m is the available number of constructed NN filter models.
      ii. In one example, m is dependent on the type of video unit.
      iii. In one example, m is dependent on the signaled parameters of video unit.
      iv. In one example, m is the default value.
      v. In one example, m is 0, 1, 2, 3, 4, etc.
   b. In one example, D in RDO criterion is the minimal value of the distortion without NN filter model and distortions with m NN filter models.
      i. In one example, m is the available number of constructed NN filter models.
      ii. In one example, m is dependent on the type of video unit.
      iii. In one example, m is dependent on the signaled parameters of video unit.
      iv. In one example, m is the default value.
      v. In one example, m is 0, 1, 2, 3, 4, etc.
   c. In one example, D in RDO criterion is combination of the distortion without NN filter model and distortions with m NN filter models.
      i. In one example, D=f₀*D_{ORG}+Σfₙ*Dⁿ_{NNLF}.
   d. In the above embodiments, the parameters m or f₀ or fₙ may be set according to the temporal layers and/or slice types.
   e. In the above embodiments, the parameters m or f₀ or fₙ may be set according to the QP (quantization parameter).
   f. In one example, the same rule of usage of NN filtering should be applied to calculate RD costs for all candidate modes and/or partitioning methods for a block.
3. The distortion D_{ORG} without NN filter model may be dependent on the other filters LFⁱ which are different with the NN filtering models (e.g., Deblocking, ALF). The distortion Dⁱ_{LF} with LFⁱ may mean that the reconstruction samples are filtered by the LFⁱ filter and the filtered reconstruction samples will be compared with the original samples to derive the distortion.
   a. In one example, the LFⁱ may be applied on the reconstruction samples before NN filtering models.
   b. In one example, the NN filtering models may be applied after LFⁱ.
   c. In one example, D_{ORG} is a scaled version of the distortion Dⁱ_{LF} with filter LF, i.e., D_{ORG}=f*D_{LF}.
   d. In one example, D_{ORG} is the combination of the distortions with multiple of other filters, i.e., D_{ORG}=Σfᵢ*Dⁱ_{LF}.

### On Implementation of the NN Filter Models in the RDO Process

4. The input of the NN filter models in RDO process may include the signal from the current video block and/or the neighboring blocks.
   a. In one example, the prediction signal and/or partitioning information and/or reconstruction signal from the current block may be involved in the NN filter process.
   b. In one example, other information from one/multiple reference frames may be involved in the NN filter process of current block.
      i. In one example, the collocated block from the first frame in list-0 and/or the collocated block from the first frame in list-1 may be involved in the NN filter process.
      ii. In one example, one/multiple motion compensated reference blocks may be involved in the NN filter process.
   c. In one example, the prediction signal and/or partitioning information and/or pixels from at least one neighboring block may be involved in the NN filter process.
      i. In one example, the neighboring blocks may be located at the left or above or left-above side of the current block.
      ii. In one example, the samples of neighboring blocks may be reconstructed.
      iii. In one example, The neighboring blocks may be located at the right or below side of the current block.
      iv. In one example, the samples of neighboring blocks may not be reconstructed.
      v. In one example, the samples of neighboring blocks may be original signal.
      vi. In one example, the samples of neighboring blocks may be derived from the current block.
   d. In one example, these above embodiments could be combined in any manner.

### On Usage of the NN Filter Models in the RDO Process

5. Whether to and/or how to utilize the NN filter models in RDO process may be dependent on the coding statistics of the video unit (e.g., prediction modes, qp, temporal layer, slice type, etc.).
   a. Whether to and/or how to utilize the NN filter models in RDO process may be dependent on the dimension of the video unit.
      i. In one example, when W<=T1 and/or H<=T2 (e.g., T1=T2=64), the NN filter models may be utilized in the RDO process.
      ii. In one example, when W>=T1 and/or H>=T2 (e.g., T1=T2=16), the NN filter models may be utilized in the RDO process.
      iii. In one example, when W*H>=T1 (e.g., T1=64), the NN filter models may be utilized in the RDO process.
      iv. In one example, when W*H<=T1 (e.g., T1=4096), the NN filter models may be utilized in the RDO process.
   b. Whether to and/or how to utilize the NN filter models in RDO process may be dependent on the color components.
      i. In one example, the NN filter models is only applied in the component X.
         1) In one example, X is Luma (Y) or Chroma (Cb or Cr).
      ii. In one example, the NN filter models is applied for all color components.
   c. Whether to and/or how to utilize the NN filter models in RDO process may be dependent on the rate distortion cost without NN filter model. J_{A} means the cost of mode A without NN filter model and J_{B} means the cost of mode B without NN filter model.
      i. In one example, NN filter models may be not applied when the cost J_{A} is greater than and/or equal than multiple of cost J_{B} (J_{A}>f₀*J_{B} or J_{A}>=f₀*J_{B}).
         1) In one example, f₀ is 1.0, 1.001, 1.005, 1.05, 1.01.
      ii. In one example, NN filter models may be not applied when the cost J_{B} is greater than and/or equal than multiple of cost J_{A} (J_{B}>f₁*J_{A} or J_{B}>=f₁*J_{A}).
         1) In one example, f₁ is 1.0, 1.001, 1.005, 1.05, 1.01.
      iii. In one example, J_{A}>f₀*J_{B}∥J_{B}>f₁*J_{A}.
      iv. In one example, NN filter models may be not applied when the ratio between cost J_{A} and cost J_{B} is greater than and/or equal than a threshold (J_{A}/J_{B}>f₂ or J_{A}/J_{B}>=f₂).
         1) In one example, f₂ is 1.0, 1.001, 1.005, 1.05, 1.01.
      v. In one example, NN filter models may be not applied when the ratio between cost J_{A} and cost J_{B} is smaller than and/or equal than a threshold (J_{A}/J_{B}<f₃ or J_{A}/J_{B}<=f₃).
         1) In one example, f₃ is 1.0, 1.001, 1.005, 1.05, 1.01.
      vi. In one example, J_{A}/J_{B}>f₂∥J_{A}/J_{B}<f₃.
      vii. In one example, NN filter models may be NOT or be applied when the cost J_{A} is equal or/and smaller or/and greater than a threshold Th_{A} and/or the cost J_{B} is equal or/and smaller or/and greater than a threshold Th_{B}.
         1) In one example, Th_{A} or The is equal to MAX_DOUBLE which is a default value.
         2) In one example, Th_{A} or The is equal to 1.7e+308.
      viii. In one example, the NN filter for mode A and mode B may be applied according to the certain or adaptive order.
         1) In one example, the order of applying the NN filter for mode A and mode B may be dependent on the coding modes/statistics of the video unit (e.g., prediction modes, qp, temporal layer, slice type, etc.).
         2) In one example, the order of applying the NN filter for mode A and mode B may be dependent on J_{A} and J_{B}.
         a. In one example, when J_{A} is greater than and/or equal than J_{B}, applying the NN filter for mode A may have a greater priority than applying the NN filter for mode B.
         b. In one example, when J_{B} is greater than and/or equal than J_{A}, applying the NN filter for mode A may have a greater priority than applying the NN filter for mode B.
      ix. In one example, J_{A} may be equal to D+lambda*R.
         1) In one example, D may be equal to D_{ORG}.
      x. In one example, J_{B} may be equal to D+lambda*R.
         1) In one example, D may be equal to D_{ORG}.
      xi. In one example, these above embodiments could be combined in any manner.
      xii. In the above embodiments, the parameters Th_{A}, Th_{B}, f₀, f₁, f₂, or f₃ may be set according to the temporal layers.
      xiii. In the above embodiments, the parameters Th_{A}, Th_{B}, f₀, f₁, f₂, or f₃ may be set according to the QP (quantization parameter).
      xiv. In the above embodiments, the parameters Th_{A}, Th_{B}, f₀, f₁, f₂, or f₃ may be set according to the slice type.
      xv. In the above embodiments, the parameters Th_{A}, Th_{B}, f₀, f₁, f₂, or f₃ may be set according to the configuration (e.g., all intra, random access, low-delay B, low-delay P, etc.).
   d. Whether to and/or how to utilize the NN filter models in RDO process may be dependent on the rate distortion cost without NN filter model and the rate distortion cost with NN filter model. J_{A} means the cost of mode A without NN filter model and J′_{B} means the cost of mode B with NN filter model.
      i. In one example, whether to apply NN filter models for mode A may be dependent on the cost J_{A} and J′_{B}.
      ii. In one example, J_{A} may be equal to D+lambda*R.
         1) In one example, D may be equal to D_{ORG}.
      iii. In one example, J′_{B} may be equal to D+lambda*R.
         1) In one example, D may be equal to min (Dⁿ_{NNLF}, D_{ORG}).
         2) In one example, D may be equal to Dⁿ_{NNLF}.
      iv. In one example, NN filter models may be not applied for mode A when the cost J_{A} is greater than and/or equal than multiple of cost J′_{B} (J_{A}>f₀ J′_{B} or J_{A}>=f₀*J′_{B}).
      v. In one example, NN filter models may be not applied for mode A when the cost J′_{B} is greater than and/or equal than multiple of cost J_{A} (J′_{B}>f₁*J_{A} or J′_{B}>=f₁*J_{A}).
      vi. In one example, J_{A}>f₀+J′_{B}∥J′_{B}>f₁*J_{A}.
      vii. In one example, NN filter models may be not applied when the ratio between cost J_{A} and cost J′_{B} is greater than and/or equal than a threshold (J_{A}/J′_{B}>f₂ or J_{A}/J′_{B}>=f₂).
      viii. In one example, NN filter models may be not applied when the ratio between cost J_{A} and cost J′_{B} is smaller than and/or equal than a threshold (J_{A}/J′_{B}<f₃ or J_{A}/J′_{B}<=f₃).
      ix. In one example, J_{A}/J′_{B}>f₂∥J_{A}/J′_{B}<f₃.
      x. In one example, these above embodiments could be combined in any manner.
      xi. In the above embodiments, the parameters f₀, f₁, f₂, or f₃ may be set according to the temporal layers.
      xii. In the above embodiments, the parameters f₀, f₁, f₂, or f₃ may be set according to the QP (quantization parameter).
      xiii. In the above embodiments, the parameters f₀, f₁, f₂, or f₃ may be set according to the slice type.
      xiv. In the above embodiments, the parameters f₀, f₁, f₂, or f₃ may be set according to the configuration (e.g., all intra, random access, low-delay B, low-delay P, etc.).
   e. In one example, NN filtering may only be applied to partial samples of a block in the RDO process.
      i. For example, NN filtering may only be applied to the center W1×H1 subblock in a W×H block.
         1) For example, W1=W/2, H1=H/2.
         2) For example, W1=3*W/4, H1=3*H/4.
   f. Whether to and/or how to utilize the NN filter models in RDO process may be dependent on the temporal layers.
      i. In one example, NN filter models may be applied to temporal layers with ID greater than K.
         1) In one example, K is equal to 0, 1, 2, 3, 4, 5, 6.
      ii. In one example, NN filter models may be applied to temporal layers with ID smaller than K.
         1) In one example, K is equal to 0, 1, 2, 3, 4, 5, 6.
   g. Whether to and/or how to utilize the NN filter models in RDO process may be dependent on the coding statistics of sub coding units.
      i. In one example, NN filter models may be NOT or be applied for the current block when NN filter models are applied to part or all of sub coding units.
      ii. In one example, NN filter models may be NOT or be applied for the current block when rate-distortion costs and/or the distortions of part or all of sub coding units are available.

### 5. Embodiment

### 5.1 Embodiment #1

In this implementation, the convolutional neural network-based in-loop filtering with adaptive model selection (DAM) is extended to the rate distortion optimization (RDO) process. And the number of residual blocks in DAM is reduced to 4. The DAM is applied to the coding unit level to select the best partitioning structure based on the RDO criterion. The rate distortion cost could be formulated as:

J=D+lambda*R

where D denotes the minimum value of distortion with DAM and without DAM.

Before applying the DAM, the cost J_{A} of partitioning mode A and the cost J_{B} of partitioning mode B are checked. When meeting the following condition, the DAM is skipped.

$${J}_{A} > {f}_{0} * {J}_{B} ‖ {J}_{B} > {f}_{1} * {J}_{A}$$

where the f₀ and f₁ are parameters.

### 5.2 Embodiment #2

### 5.2.1 Proposed Method

It is proposed that CNN-based filtering is involved during the partitioning mode selection. In particular, the samples obtained after CNN-based filtering are compared with original samples to calculate the distortion. The optimal partitioning mode is then selected based on the refined rate-distortion (RD) cost.

To reduce the complexity of applying CNN-based filtering in RDO, several fast algorithms are proposed. First, a simplified version of CNN model as shown in FIG. 16A and FIG. 16B is additionally trained and used in the RDO stage where the simplified model is implemented with SADL using fixed point-based calculation. Second, only one filter is included in the RDO process without considering filter selection. Finally, the proposed technique is only applied to the coding units with height and width no larger than 64. FIG. 16A illustrates an example diagram showing architecture of the proposed CNN filter, where M denotes the number of feature maps and N stands for the number of samples in one dimension. FIG. 16B illustrates an example diagram showing a construction of Attention Residual Block in FIG. 16A.

The inference and training processes of models are same as those in JVET-AA0111.

### 6.2.2 Inference

SADL is used for to perform the inference of the proposed CNN filters in RDO process. The network information in the inference stage is provided in Table 6.

TABLE 6
Network Information for NN-based Video
Coding Tool Testing in Inference Stage
Network Information in Inference Stage

| | HW environment: | |
|---|---|---|
| Mandatory | GPU Type | N/A |
| | Framework: | SADL |
| | Number of GPUs per Task | 0 |
| | Total Parameter Number | 1.56 M/model (4 models) |
| | Parameter Precision (Bits) | 16 for fixed point version |
| | Memory Parameter (MB) | 3.1 MB/model (4 models) |
| | MAC (Giga) | 539K/pixel |
| Optional | Total Conv. Layers | 25 + 16 |
| | Total FC Layers | 0 |
| | Total Memory (MB) | |
| | Batch size: | 1 |
| | Patch size | 128 × 128, 256 × 256 |
| | Changes to network | |
| | configuration or weights | |
| | required to generate rate points | |
| | Peak Memory Usage | |
| | Other information: | |

### 6.2.3 Training

PyTorch is used as the training platform. The DIV2K and BVI-DVC datasets are adopted to train the CNN filters of I slices and B slices, respectively. The network information in the training stage is provided in Table 7.

TABLE 7
Network Information for NN-based Video Coding
Tool Testing in Training Stage
Network Information in Training Stage

| | | |
|---|---|---|
| Mandatory | GPU Type | GPU: Tesla-V100- |
| | | SXM2-32GB |
| | Framework: | PyTorch v1.6 |
| | Number of GPUs per Task | 2 |
| | Epoch: | 50 |
| | Batch size: | 64 |
| | Training time: | 60h/model |
| | Training data information: | DIV2K, BVI-DVC |
| | Training configurations for | VTM-11.0 + new MCTF, |
| | generating compressed | QP { 17, 22, 27, 32, 37, 42} |
| | training data (if different to | |
| | VTM CTC): | |
| | Loss function: | L1, L2 |
| Optional | Number of iterations | |
| | Patch size | 128 × 128 |
| | Learning rate: | 1e−4 |
| | Optimizer: | ADAM |
| | Preprocessing: | |
| | Other information: | |

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. As used herein, the term “an independent filter (ID) filter” may refer to a filter is not exactly same with other filters and some parts of the filters are different, such as the input of the filter, the structure of the filter, the parameters of filter, the neural network model of the filter. In one example, the design of ID-Filter is unique and different with the design of other filters. In one example, the inputs of ID-Filter are different when filters share the consistent structure or consistent parameters or consistent model of neural network. ID-Filter can be any kind of filters, including filters without neural network (non-NN filter) and filters with neural network (NN filter). A Non-NN Filter may be one of deblocking filter (DF), sample adaptive offset (SAO), adaptive loop filter (ALF), etc. A NN filter can be any kind of NN filter, such as a convolutional neural network (CNN) filter. In the following discussion, a NN filter may also be referred to as a CNN filter.

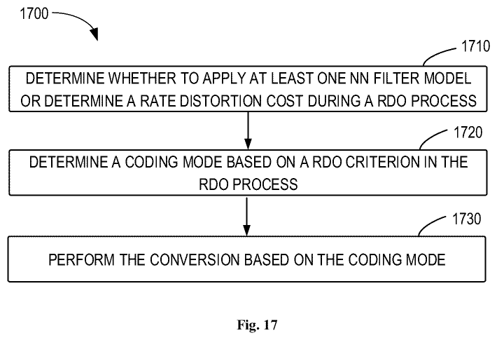

FIG. 17 illustrates a flowchart of a method 1700 for video processing in accordance with embodiments of the present disclosure. The method 1700 is implemented during a conversion between a target video block of a video and a bitstream of the video.

At block 1710, for a conversion between a video unit of a video and a bitstream of the video unit, it is determined to whether to apply at least one neural network (NN) filter model or determine a rate distortion cost during a rate distortion optimization (RDO) process of the video unit based on at least one of: a distortion without NN filter model, a distortion with n-th NN filter model, a combination of distortions of a plurality of NN filter models, or coding statistics of the video unit, and wherein n is an integer number.

At block 1720, a coding mode of the video unit is determined based on a rate distortion optimization (RDO) criterion in the RDO process.

At block 1730, the conversion is performed based on the coding mode. Alternatively, or in addition, the conversion may include decoding the video unit from the bitstream. In this way, the impact of reduce distortion due to NN filter is taken into consideration during the RDO process, thereby improving coding performances.

In some embodiments, the method 1700 further comprises: determining an approach to apply the at least one neural network (NN) filter model or determine the rate distortion cost during the RDO process of the video unit based on at least one of: the distortion without NN filter model, the distortion with n-th NN filter model, or the combination of distortions of the plurality of NN filter models.

In some embodiments, the distortion with the n-th NN filter model is derived by comparing filter reconstruction samples which are filtered by the n-th NN filter model with original samples. In some embodiments, the distortion in the RDO criterion is represented as J=D+lambda*R, where D represents a distortion, lambda represents a coefficient parameter, R represents a rate associated with a candidate coding mode.

In some embodiments, the distortion in the RDO criterion is the distortion with the n-th NN filter model. In some embodiments, the distortion in the RDO criterion is a minimal value of the distortion without NN filter model and the distortion with the n-th NN filter model. In some embodiments, n is one of: 1, 2, 3.

In some embodiments, the distortion in the RDO criterion is a distortion with a best NN filter model. In some embodiments, the distortion in the RDO criterion is a minimal value of distortion without NN filter model and a distortion with a best NN filter model.

In some embodiments, the best NN filter model is selected by distortion. In some embodiments, the best NN filter model is a default one.

In some embodiments, the distortion in the RDO criterion is the distortion without NN filter model multiplied a scaling factor. In some embodiments, the scaling factor is one of 1.0, 0.9, or 1.1.

In some embodiments, the distortion in the RDO criterion is derived according to the distortion without NN filter model and the distortion with the n-th NN filter model.

In some embodiments, the distortion in the RDO criterion is derived as D=f₀*D_{ORG}+f₁*Dⁿ_{NNLF}, and where D represents the distortion in the RDO criterion, f₀ represents a first scaling factor, f₁ represents a second scaling factor, D_{ORG} represents the distortion without NN filter model, and Dⁿ_{NNLF} represents the distortion with the n-th NN filter model. In some embodiments, f₀=0.0, f₁=1.0, or f₀=1.0, f₁=0.0.

In some embodiments, the distortion in the RDO criterion is derived as: min (f₀*D_{ORG}, f₁*Dⁿ_{NNLF}), and where D represents the distortion in the RDO criterion, f₀ represents a first scaling factor, f₁ represents a second scaling factor, D_{ORG} represents the distortion without NN filter model, and Dⁿ_{NNLF} represents the distortion with the n-th NN filter model. In some embodiments, f₀=1.0, f₁=1.0.

In some embodiments, the distortion in the RDO criterion is a combination of one or more of: the distortion with the n-th NN filter model, a minimal value of the distortion without NN filter model and the distortion with the n-th NN filter model, a distortion with a best NN filter model, a minimal value of distortion without NN filter model and a distortion with a best NN filter model, the distortion without NN filter model multiplied a scaling factor, or a derivation according to the distortion without NN filter model and the distortion with the n-th NN filter model. In some embodiments, the combination is dependent on coding statistics of the video unit. In some embodiments, the combination is dependent on a type of candidate mode.

In some embodiments, if one or all of candidate modes are not partitioning mode, the distortion in the RDO criterion is a combination of at least one of: a distortion with p-th NN filter model or the distortion without NN filter model, where p is an integer number. In some embodiments, if the p-th NN filter model is not applied for the one or all of candidate modes, the distortion in the RDO criterion is the distortion without NN filter model. In some embodiments, if the p-th NN filter model is applied for the one or all of candidate modes, the distortion in the RDO criterion is the distortion with the p-th NN filter model. In some embodiments, if one or all of candidate modes are partitioning modes, the distortion in the RDO criterion is a combination of at least one of: a distortion with q-th NN filter model, a distortion with p-th NN filter model, or the distortion without NN filter model, wherein p and q are integer numbers.

In some embodiments, the combination is dependent on at least one of: usage of q-th NN filter model or usage of p-th NN filter model, where p and q are integer numbers. In some embodiments, if the q-th NN filter model is applied for one or all of candidate modes, the distortion in the RDO criterion is the minimal value of the distortion without NN filter model and distortion with the q-th NN filter model. In some embodiments, if the q-th NN filter model is not applied for one or all of candidate modes, the distortion in the RDO criterion is a combination of the distortion with the p-th NN filter model and the distortion without NN filter model. In some embodiments, if the p-th NN filter model is applied for the one or all of candidate modes, the distortion in the RDO criterion is the distortion with the p-th NN filter model. In some embodiments, if the p-th NN filter model is not applied for the one or all of candidate modes, the distortion in the RDO criterion is the distortion without NN filter model.

In some embodiments, an approach of determining the distortion in the RDO criterion is applied according to a predefined order or an adaptive order. In some embodiments, the order of applying the approach of determining the distortion in the RDO criterion is dependent on at least one of: a coding mode of the video unit or coding statistics of the video unit.

In some embodiments, an approach of determining the distortion in the RDO criterion as the minimal value of the distortion without NN filter model and distortion with the q-th NN filter model has a higher priority than an approach of determining the distortion in the RDO criterion as the distortion with the p-th NN filter model. In some embodiments, an approach of determining the distortion in the RDO criterion as the distortion with the p-th NN filter model has a higher priority than an approach of determining the distortion in the RDO criterion as the distortion without NN filter model.

In some embodiments, the p-th NN filter model is one of: a deblocking filter, a sample adaptive offset (SAO) filter, or an adaptive loop filter (ALF). In some embodiments, the q-th NN filter model is a convolutional neural network (CNN) filter. In some embodiments, the q-th NN filter model is the same with the p-th NN filter model. In some embodiments, p is equal to q.

In some embodiments, a number of candidate modes are comparable modes with the RDO criterion which is represented as J=D+lambda*R. In some embodiments, the number candidate modes is equal to 1 or 2 or 3 or 4.

In some embodiments, at least one of: f, f₀ or f₁ is set according to at least one of: a temporal layer or a slice type. In some embodiments, at least one of: f, f₀ or f₁ is set according to quantization parameter (QP). In some embodiments, at least one of: f, f₀ or f₁ is set according to a configuration associated with the video unit. In some embodiments, a same rule of usage of NN filtering is applied to determine the rate distortion cost for at least one of: all candidate modes or partitioning approaches for the video unit.

In some embodiments, the distortion in the RDO criterion is the minimal value of distortions with m NN filter models, where m is an integer number. In some embodiments, the distortion in the RDO criterion is a minimal value of the distortion without NN filter model and distortions with m NN filter models, where m is an integer number.

In some embodiments, m is an available number of constructed NN filter models. In some embodiments, m is dependent on a type of video unit. In some embodiments, m is dependent on a signaled parameter of video unit. In some embodiments, m is a default value. In some embodiments, m is one of: 0, 1, 2, 3, or 4.

In some embodiments, the distortion in the RDO criterion is a combination of the distortion without NN filter model and distortions with m NN filter models, where m is an integer number. In some embodiments, the distortion in the RDO criterion is derived as: D=f₀*D_{ORG}+Σfₙ*Dⁿ_{NNLF}, where D represents the distortion in the RDO criterion, f₀ represents a first scaling factor, f₁ represents a second scaling factor, D_{ORG} represents the distortion without NN filter model, and Dⁿ_{NNLF} represents the distortion with the n-th NN filter model.

In some embodiments, at least one of: m, f₀ or fₙ is set according to at least one of: a temporal layer or a slice type. In some embodiments, at least one of: m, f₀ or fₙ is set according to quantization parameter (QP). In some embodiments, a same rule of usage of NN filtering is applied to determine the rate distortion cost for at least one of: all candidate modes or partitioning approaches for the video unit.

In some embodiments, the distortion without NN filter model is dependent on another filter which is different with the at least one NN filter model. In some embodiments, the distortion with the other filter is derived by comparing filter reconstruction samples which are filtered by the other filter with original samples. In some embodiments, the other filter is applied on reconstruction samples before the at least one NN filter model.

In some embodiments, the at least one NN filter model is applied after the other filter. In some embodiments, the distortion without NN filter model is the distortion with the other filter multiplied a scaling factor. In some embodiments, the distortion without NN filter model is a combination of the distortions with a plurality of other filters.

In some embodiments, an input of the at least one NN filter model in the RDO process include a signal from at least one of: a current block or a neighboring block. In some embodiments, at least one of the followings from the current block is involved in a NN filter process: a prediction signal, partitioning information, or a reconstruction signal.

In some embodiments, other information from one or more reference frames is involved in a NN filter process of the video unit. In some embodiments, at least one of: a collocated block from a first frame in list-0, or a collocated block from a first frame in list-1 is involved in the NN filter process. In some embodiments, one or more motion compensated reference blocks are involved in the NN filter process.

In some embodiments, at least one of the following from at least one neighboring block is involved in a NN filter process of the video unit: a prediction signal, partitioning information, or pixels. In some embodiments, the at least one neighboring block is located at one of: a left side of the video unit, an above side of the video unit, or a left-above side of the video unit. In some embodiments, samples of the at least one neighboring block are reconstructed. In some embodiments, the at least one neighboring block is located at a right side or a below side of the video unit.

In some embodiments, samples of neighboring blocks are no reconstructed. In some embodiments, samples of neighboring blocks are an original signal. In some embodiments, samples of neighboring blocks are derived from the video unit.

In some embodiments, the coding statistics comprises at least one of: a prediction mode, QP, a temporal layer, a slice type, or a dimension of the video unit.

In some embodiments, if a width of the video unit is less than or equal to a first threshold and a height of the video unit is less than or equal to a second threshold, the at least one NN filter model is applied in the RDO process. In some embodiments, the first threshold is 64 and the second threshold is 64.

In some embodiments, if a width of the video unit is larger than or equal to a first threshold and a height of the video unit is larger than or equal to a second threshold, the at least one NN filter model is applied in the RDO process. In some embodiments, the first threshold is 16 and the second threshold is 16.

In some embodiments, if a value of the width of the video unit multiplying the height of the video unit is larger than or equal to a third threshold, the at least one NN filter model is applied in the RDO process. In some embodiments, the third threshold is 64.

In some embodiments, if a value of the width of the video unit multiplying the height of the video unit is less than or equal to a fourth threshold, the at least one NN filter model is applied in the RDO process. In some embodiments, the fourth threshold is 4094.

In some embodiments, the method 1700 further comprises: determining whether to and/or the approach to apply the at least one NN filter in the RDO process based on color components. In some embodiments, the at least one NN filter model is only applied in a certain color component. In some embodiments, the certain component is Luma component or Chroma component. In some embodiments, the at least one NN filter model is applied for all color components.

In some embodiments, the method 1700 further comprises: determining whether to and/or the approach to apply the at least one NN filter in the RDO process based on a rate distortion cost without NN filter model.

In some embodiments, if a first rate distortion cost of a first coding mode is higher than or equal to a second rate distortion cost of a second coding mode multiplied a first factor, the at least one NN filter is not applied. In some embodiments, the first factor is one of: 1.0, 1.001, 1.005, 1.05, or 1.01.

In some embodiments, if a second rate distortion cost of a second coding mode is higher than or equal to a first rate distortion cost of a first coding mode multiplied a second factor, the at least one NN filter is not applied. In some embodiments, the second factor is one of: 1.0, 1.001, 1.005, 1.05, or 1.01. In some embodiments, if a first rate distortion cost of a first coding mode is higher than or equal to a second rate distortion cost of a second coding mode multiplied a first factor, or if a second rate distortion cost of a second coding mode is higher than or equal to a first rate distortion cost of a first coding mode multiplied a second factor, the at least one NN filter is not applied.

In some embodiments, if a ratio between a first rate distortion cost of a first coding mode and a second rate distortion cost of a second coding mode is higher than or equal to a first ratio threshold, the at least one NN filter model is not applied. In some embodiments, the first ratio threshold is one of: 1.0, 1.001, 1.005, 1.05, or 1.01.

In some embodiments, if a ratio between a first rate distortion cost of a first coding mode and a second rate distortion cost of a second coding mode is less than or equal to a second ratio threshold, the at least one NN filter model is not applied. In some embodiments, the second ratio threshold is one of: 1.0, 1.001, 1.005, 1.05, or 1.01. In some embodiments, if a ratio between a first rate distortion cost of a first coding mode and a second rate distortion cost of a second coding mode is higher than or equal to a first ratio threshold or if a ratio between a first rate distortion cost of a first coding mode and a second rate distortion cost of a second coding mode is less than or equal to a second ratio threshold, the at least one NN filter is not applied.

In some embodiments, the at least one NN filter is not applied, if one of the followings is satisfied: a first rate distortion cost of a first coding mode is equal to a first cost threshold and a second rate distortion of a second coding mode is equal to a second cost threshold, the first rate distortion cost is smaller than the first cost threshold and the second rate distortion is smaller than the second cost threshold, or the first rate distortion cost is higher than the first cost threshold and the second rate distortion is higher than the second cost threshold. In some embodiments, the at least one NN filter is applied, if one of the followings is satisfied: a first rate distortion cost of a first coding mode is equal to a first cost threshold and a second rate distortion of a second coding mode is equal to a second cost threshold, the first rate distortion cost is smaller than the first cost threshold and the second rate distortion is smaller than the second cost threshold, or the first rate distortion cost is higher than the first cost threshold and the second rate distortion is higher than the second cost threshold.

In some embodiments, the first cost threshold or the second cost threshold is equal to MAX_DOUBLE which is a default value. In some embodiments, the first cost threshold or the second cost threshold is equal to 1.7e+308.

In some embodiments, the at least one NN filer for a first coding mode and a second coding mode is applied according to a predefined order or an adaptive order. In some embodiments, an order of applying the at least one NN filer for the first coding mode and the second coding mode is dependent on at least one of: a coding mode of the video unit and coding statistics of the video unit. In some embodiments, an order of applying the at least one NN filer for the first coding mode and the second coding mode is dependent on a first rate distortion cost of a first coding mode and a second rate distortion of a second coding mode.

In some embodiments, if the first rate distortion cost of the first coding mode is higher than or equal to the second rate distortion cost of the second coding mode, applying the at least one NN filter to the first coding mode has a higher priority than applying the at least one NN filter to the second coding mode. In some embodiments, if the second rate distortion cost of the second coding mode is higher than or equal to the first rate distortion cost of the first coding mode, applying the at least one NN filter to the first coding mode has a higher priority than applying the at least one NN filter to the second coding mode.

In some embodiments, a first rate distortion cost of a first coding mode is equal to the RDO criterion in the RDO process. In some embodiments, a second rate distortion cost of a second coding mode is equal to the RDO criterion in the RDO process. In some embodiments, the distortion in the RDO criterion is equal to the distortion without NN filter model.

In some embodiments, at least one of the first threshold, the second threshold, the third threshold, the fourth threshold, the first cost threshold, or the second cost threshold is set according to temporal layers. In some embodiments, at least one of the first threshold, the second threshold, the third threshold, the fourth threshold, the first cost threshold, or the second cost threshold is set according to the QP. In some embodiments, at least one of the first threshold, the second threshold, the third threshold, the fourth threshold, the first cost threshold, or the second cost threshold is set according to a slice type. In some embodiments, at least one of the first threshold, the second threshold, the third threshold, the fourth threshold, the first cost threshold, or the second cost threshold is set according to a configuration of the video unit.

In some embodiments, the method 1700 further comprises: determining whether to and/or the approach to apply the at least one NN filter in the RDO process based on a rate distortion cost without NN filter model and a rate distortion cost with NN filter.

In some embodiments, whether to apply the at least one NN filter model for a first coding mode is dependent on a rate distortion cost of the first coding mode without NN filter model and a rate distortion cost of a second coding mode with NN filter model. In some embodiments, a rate distortion cost of the first coding mode without NN filter model is equal to the RDO criterion in the RDO process. In some embodiments, the distortion in the RDO criterion is equal to the distortion without NN filter model. In some embodiments, a rate distortion cost of a second coding mode with NN filter model is equal to the RDO criterion in the RDO process.

In some embodiments, the distortion in the RDO criterion is equal to a minimal value of the distortion without NN filter model and the distortion with the n-th NN filter model. In some embodiments, the distortion in the RDO criterion is equal to the distortion with the n-th NN filter model.

In some embodiments, if a rate distortion cost of the first coding mode without NN filter model is higher than or equal to a rate distortion cost of a second coding mode with NN filter model multiplied a first scaling factor, the at least one NN filter is not applied for the first coding mode. In some embodiments, if a rate distortion cost of a second coding mode with NN filter model multiplied a second scaling factor is higher than or equal to a rate distortion cost of the first coding mode without NN filter model, the at least one NN filter is not applied for the first coding mode. In some embodiments, if a rate distortion cost of the first coding mode without NN filter model is higher than or equal to a rate distortion cost of a second coding mode with NN filter model multiplied a first scaling factor, or if the rate distortion cost of the second coding mode with NN filter model multiplied a second scaling factor is higher than or equal to the rate distortion cost of the first coding mode without NN filter model, the at least one NN filter is not applied for the first coding mode.

In some embodiments, if a ratio between a rate distortion cost of the first coding mode without NN filter model and a rate distortion cost of a second coding mode with NN filter model is higher than or equal to a first ratio threshold, the at least one NN filter model is not applied. In some embodiments, if a ratio between a rate distortion cost of the first coding mode without NN filter model and a rate distortion cost of a second coding mode with NN filter model is less than or equal to a second ratio threshold, the at least one NN filter model is not applied. In some embodiments, if a ratio between a rate distortion cost of the first coding mode without NN filter model and a rate distortion cost of a second coding mode with NN filter model is higher than or equal to a first ratio threshold, or if a ratio between the rate distortion cost of the first coding mode without NN filter model and the rate distortion cost of the second coding mode with NN filter model is less than or equal to a second ratio threshold, the at least one NN filter is not applied.

In some embodiments, at least one of: the first scaling factor, the second scaling factor, the first ratio threshold, or the second ratio threshold is set according to temporal layers. In some embodiments, at least one of: the first scaling factor, the second scaling factor, the first ratio threshold, or the second ratio threshold is set according to the QP. In some embodiments, at least one of: the first scaling factor, the second scaling factor, the first ratio threshold, or the second ratio threshold is set according to a slice type. In some embodiments, at least one of: the first scaling factor, the second scaling factor, the first ratio threshold, or the second ratio threshold is set according to a configuration of the video unit.

In some embodiments, the at least one NN filter is only applied to partial samples of a block in the RDO process. In some embodiments, the at least one NN filter is only applied to a center subblock in the block. In some embodiments, a width of the subblock is equal to half of width of the block, and a height of the subblock is equal to half of height of the block. In some embodiments, a width of the subblock is equal to three quarters of width of the block, and a height of the subblock is equal to three quarters of height of the block.

In some embodiments, the method 1700 further comprises: determining whether to and/or the approach to apply the at least one NN filter in the RDO process based on temporal layers. In some embodiments, the at least one NN filter is applied to the temporal layer with ID which is greater than K. In some embodiments, the at least one NN filter is applied to the temporal layer with ID which is smaller than K, where K is an integer number. In some embodiments, K is equal to one of 0, 1, 2, 3, 4, 5, or 6.

In some embodiments, the method 1700 further comprises: determining whether to and/or the approach to apply the at least one NN filter in the RDO process based on coding statistics of sub coding units. In some embodiments, if the at least one NN filter is applied to a portion or all of the sub coding units, the at least one NN filter is not applied to the video unit. In some embodiments, if the at least one NN filter is applied to the portion or all of the sub coding units, the at least one NN filter is applied to the video unit.

In some embodiments, if at least one of: rate-distortion costs or distortions of the portion or all of the sub coding units are available, the at least one NN filter is not applied to the video unit. In some embodiments, if at least one of: rate-distortion costs or distortions of the portion or all of the sub coding units are available, the at least one NN filter is applied to the video unit.

According to further embodiments of the present disclosure, a non-transitory computer-readable recording medium is provided. The non-transitory computer-readable recording medium stores a bitstream of a video which is generated by a method performed by an apparatus for video processing. The method comprises: determining whether to apply at least one neural network (NN) filter model or determine a rate distortion cost during a rate distortion optimization (RDO) process of a video unit of the video based on at least one of: a distortion without NN filter model, a distortion with n-th NN filter model, a combination of distortions of a plurality of NN filter models, or coding statistics of the video unit, and wherein n is an integer number; determining a coding mode of the video unit based on a rate distortion optimization (RDO) criterion in the RDO process; and generating the bitstream based on the coding mode.

According to still further embodiments of the present disclosure, a method for storing bitstream of a video is provided. The method comprises: determining whether to apply at least one neural network (NN) filter model or determine a rate distortion cost during a rate distortion optimization (RDO) process of a video unit of the video based on at least one of: a distortion without NN filter model, a distortion with n-th NN filter model, a combination of distortions of a plurality of NN filter models, or coding statistics of the video unit, and wherein n is an integer number; determining a coding mode of the video unit based on a rate distortion optimization (RDO) criterion in the RDO process; generating the bitstream based on the coding mode; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video unit, whether to apply at least one neural network (NN) filter model or determine a rate distortion cost during a rate distortion optimization (RDO) process of the video unit based on at least one of: a distortion without NN filter model, a distortion with n-th NN filter model, a combination of distortions of a plurality of NN filter models, or coding statistics of the video unit, and wherein n is an integer number; determining a coding mode of the video unit based on a rate distortion optimization (RDO) criterion in the RDO process; and performing the conversion based on the coding mode.

Clause 2. The method of clause 1, further comprising: determining an approach to apply the at least one neural network (NN) filter model or determine the rate distortion cost during the RDO process of the video unit based on at least one of: the distortion without NN filter model, the distortion with n-th NN filter model, or the combination of distortions of the plurality of NN filter models.

Clause 3. The method of clause 1 or 2, wherein the distortion with the n-th NN filter model is derived by comparing filter reconstruction samples which are filtered by the n-th NN filter model with original samples, and wherein the distortion in the RDO criterion is represented as J=D+lambda*R, wherein D represents a distortion, lambda represents a coefficient parameter, R represents a rate associated with a candidate coding mode.

Clause 4. The method of any of clauses 1-3, wherein the distortion in the RDO criterion is the distortion with the n-th NN filter model.

Clause 5. The method of any of clauses 1-3, wherein the distortion in the RDO criterion is a minimal value of the distortion without NN filter model and the distortion with the n-th NN filter model.

Clause 6. The method of clause 4 or 5, wherein n is one of: 1, 2, 3.

Clause 7. The method of any of clauses 1-3, wherein the distortion in the RDO criterion is a distortion with a best NN filter model.

Clause 8. The method of any of clauses 1-3, wherein the distortion in the RDO criterion is a minimal value of distortion without NN filter model and a distortion with a best NN filter model.

Clause 9. The method of clause 7, wherein the best NN filter model is selected by distortion, or wherein the best NN filter model is a default one.

Clause 10. The method of any of clauses 1-3, wherein the distortion in the RDO criterion is the distortion without NN filter model multiplied a scaling factor.

Clause 11. The method of clause 10, wherein the scaling factor is one of 1.0, 0.9, or 1.1.

Clause 12. The method of any of clauses 1-3, wherein the distortion in the RDO criterion is derived according to the distortion without NN filter model and the distortion with the n-th NN filter model.

Clause 13. The method of clause 12, wherein the distortion in the RDO criterion is derived as: D=f₀*D_{ORG}+f₁*Dⁿ_{NNLF}, and wherein D represents the distortion in the RDO criterion, f₀ represents a first scaling factor, f₁ represents a second scaling factor, D_{ORG} represents the distortion without NN filter model, and Dⁿ_{NNLF} represents the distortion with the n-th NN filter model.

Clause 14. The method of clause 13, wherein f₀=0.0, f₁=1.0, or wherein f₀=1.0, f₁=0.0.

Clause 15. The method of clause 12, wherein the distortion in the RDO criterion is derived as: min (f₀*D_{ORG}, f₁*Dⁿ_{NNLF}), and wherein D represents the distortion in the RDO criterion, f₀ represents a first scaling factor, f₁ represents a second scaling factor, D_{ORG} represents the distortion without NN filter model, and Dⁿ_{NNLF} represents the distortion with the n-th NN filter model.

Clause 16. The method of clause 15, wherein f₀=1.0, f₁=1.0.

Clause 17. The method of any of clauses 1-3, wherein the distortion in the RDO criterion is a combination of one or more of: the distortion with the n-th NN filter model, a minimal value of the distortion without NN filter model and the distortion with the n-th NN filter model, a distortion with a best NN filter model, a minimal value of distortion without NN filter model and a distortion with a best NN filter model, the distortion without NN filter model multiplied a scaling factor, or a derivation according to the distortion without NN filter model and the distortion with the n-th NN filter model.

Clause 18. The method of clause 17, wherein the combination is dependent on coding statistics of the video unit.

Clause 19. The method of clause 18, wherein the combination is dependent on a type of candidate mode.

Clause 20. The method of clause 17, wherein if one or all of candidate modes are not partitioning mode, the distortion in the RDO criterion is a combination of at least one of: a distortion with p-th NN filter model or the distortion without NN filter model, wherein p is an integer number.

Clause 21. The method of clause 20, wherein if the p-th NN filter model is not applied for the one or all of candidate modes, the distortion in the RDO criterion is the distortion without NN filter model.

Clause 22. The method of clause 20, wherein if the p-th NN filter model is applied for the one or all of candidate modes, the distortion in the RDO criterion is the distortion with the p-th NN filter model.

Clause 23. The method of clause 17, wherein if one or all of candidate modes are partitioning modes, the distortion in the RDO criterion is a combination of at least one of: a distortion with q-th NN filter model, a distortion with p-th NN filter model, or the distortion without NN filter model, wherein p and q are integer numbers.

Clause 24. The method of clause 17, wherein the combination is dependent on at least one of: usage of q-th NN filter model or usage of p-th NN filter model, wherein p and q are integer numbers.

Clause 25. The method of clause 24, wherein if the q-th NN filter model is applied for one or all of candidate modes, the distortion in the RDO criterion is the minimal value of the distortion without NN filter model and distortion with the q-th NN filter model.

Clause 26. The method of clause 24, wherein if the q-th NN filter model is not applied for one or all of candidate modes, the distortion in the RDO criterion is a combination of the distortion with the p-th NN filter model and the distortion without NN filter model.

Clause 27. The method of clause 26, wherein if the p-th NN filter model is applied for the one or all of candidate modes, the distortion in the RDO criterion is the distortion with the p-th NN filter model.

Clause 28. The method of clause 26, wherein if the p-th NN filter model is not applied for the one or all of candidate modes, the distortion in the RDO criterion is the distortion without NN filter model.

Clause 29. The method of clause 17, wherein an approach of determining the distortion in the RDO criterion is applied according to a predefined order or an adaptive order.

Clause 30. The method of clause 29, wherein the order of applying the approach of determining the distortion in the RDO criterion is dependent on at least one of: a coding mode of the video unit or coding statistics of the video unit.

Clause 31. The method of clause 29, wherein an approach of determining the distortion in the RDO criterion as the minimal value of the distortion without NN filter model and distortion with the q-th NN filter model has a higher priority than an approach of determining the distortion in the RDO criterion as the distortion with the p-th NN filter model.

Clause 32. The method of clause 29, wherein an approach of determining the distortion in the RDO criterion as the distortion with the p-th NN filter model has a higher priority than an approach of determining the distortion in the RDO criterion as the distortion without NN filter model.

Clause 33. The method of any of clauses 17-32, wherein the p-th NN filter model is one of: a deblocking filter, a sample adaptive offset (SAO) filter, or an adaptive loop filter (ALF).

Clause 34. The method of any of clauses 17-32, wherein the q-th NN filter model is a convolutional neural network (CNN) filter.

Clause 35. The method of any of clauses 17-32, wherein the q-th NN filter model is the same with the p-th NN filter model.

Clause 36. The method of clause 15, wherein p is equal to q.

Clause 37. The method of clause 17, wherein a number of candidate modes are comparable modes with the RDO criterion which is represented as J=D+lambda*R.

Clause 38. The method of clause 17, wherein the number candidate modes is equal to 1 or 2 or 3 or 4.

Clause 39. The method of any of clauses 1-38, wherein at least one of: f, f₀ or f₁ is set according to at least one of: a temporal layer or a slice type.

Clause 40. The method of any of clauses 1-38, wherein at least one of: f, f₀ or f₁ is set according to quantization parameter (QP).

Clause 41. The method of any of clauses 1-38, wherein at least one of: f, f₀ or f₁ is set according to a configuration associated with the video unit.

Clause 42. The method of any of clauses 1-41, wherein a same rule of usage of NN filtering is applied to determine the rate distortion cost for at least one of: all candidate modes or partitioning approaches for the video unit.

Clause 43. The method of any of clauses 1-3, wherein the distortion in the RDO criterion is the minimal value of distortions with m NN filter models, wherein m is an integer number, or wherein the distortion in the RDO criterion is a minimal value of the distortion without NN filter model and distortions with m NN filter models, wherein m is an integer number.

Clause 44. The method of clause 43, wherein m is an available number of constructed NN filter models.

Clause 45. The method of clause 43, wherein m is dependent on a type of video unit.

Clause 46. The method of clause 43, wherein m is dependent on a signaled parameter of video unit.

Clause 47. The method of clause 43, wherein m is a default value.

Clause 48. The method of clause 43, wherein m is one of: 0, 1, 2, 3, or 4.

Clause 49. The method of any of clauses 1-3, wherein the distortion in the RDO criterion is a combination of the distortion without NN filter model and distortions with m NN filter models, wherein m is an integer number.

Clause 50. The method of clause 49, wherein the distortion in the RDO criterion is derived as: D=f₀*D_{ORG}+Σfₙ*Dⁿ_{NNLF}, and wherein D represents the distortion in the RDO criterion, f₀ represents a first scaling factor, f₁ represents a second scaling factor, D_{ORG} represents the distortion without NN filter model, and Dⁿ_{NNLF} represents the distortion with the n-th NN filter model.

Clause 51. The method of any of clauses 43-50, wherein at least one of: m, f₀ or fₙ is set according to at least one of: a temporal layer or a slice type.

Clause 52. The method of any of clauses 43-50, wherein at least one of: m, f₀ or fₙ is set according to quantization parameter (QP).

Clause 53. The method of any of clauses 43-52, wherein a same rule of usage of NN filtering is applied to determine the rate distortion cost for at least one of: all candidate modes or partitioning approaches for the video unit.

Clause 54. The method of any of clauses 1-3, wherein the distortion without NN filter model is dependent on another filter which is different with the at least one NN filter model.

Clause 55. The method of clause 54, wherein the distortion with the other filter is derived by comparing filter reconstruction samples which are filtered by the other filter with original samples.

Clause 56. The method of clause 54, wherein the other filter is applied on reconstruction samples before the at least one NN filter model.

Clause 57. The method of clause 54, wherein the at least one NN filter model is applied after the other filter.

Clause 58. The method of clause 54, wherein the distortion without NN filter model is the distortion with the other filter multiplied a scaling factor.

Clause 59. The method of clause 54, wherein the distortion without NN filter model is a combination of the distortions with a plurality of other filters.

Clause 60. The method of any of clauses 1-3, wherein an input of the at least one NN filter model in the RDO process include a signal from at least one of: a current block or a neighboring block.

Clause 61. The method of clause 60, wherein at least one of the followings from the current block is involved in a NN filter process: a prediction signal, partitioning information, or a reconstruction signal.

Clause 62. The method of clause 60 or 61, wherein other information from one or more reference frames is involved in a NN filter process of the video unit.

Clause 63. The method of clause 62, wherein at least one of: a collocated block from a first frame in list-0, or a collocated block from a first frame in list-1 is involved in the NN filter process.

Clause 64. The method of clause 62, wherein one or more motion compensated reference blocks are involved in the NN filter process.

Clause 65. The method of any of clauses 60-64, wherein at least one of the following from at least one neighboring block is involved in a NN filter process of the video unit: a prediction signal, partitioning information, or pixels.

Clause 66. The method of clause 65, wherein the at least one neighboring block is located at one of: a left side of the video unit, an above side of the video unit, or a left-above side of the video unit.

Clause 67. The method of clause 65, wherein samples of the at least one neighboring block are reconstructed.

Clause 68. The method of clause 65, wherein the at least one neighboring block is located at a right side or a below side of the video unit.

Clause 69. The method of clause 65, wherein samples of neighboring blocks are no reconstructed.

Clause 70. The method of clause 65, wherein samples of neighboring blocks are an original signal.

Clause 71. The method of clause 65, wherein samples of neighboring blocks are derived from the video unit.

Clause 72. The method of any of clauses 1-3, wherein the coding statistics comprises at least one of: a prediction mode, QP, a temporal layer, a slice type, or a dimension of the video unit.

Clause 73. The method of any of clauses 1-3, wherein if a width of the video unit is less than or equal to a first threshold and a height of the video unit is less than or equal to a second threshold, the at least one NN filter model is applied in the RDO process.

Clause 74. The method of clause 73, wherein the first threshold is 64 and the second threshold is 64.

Clause 75. The method of any of clauses 1-3, wherein if a width of the video unit is larger than or equal to a first threshold and a height of the video unit is larger than or equal to a second threshold, the at least one NN filter model is applied in the RDO process.

Clause 76. The method of clause 75, wherein the first threshold is 16 and the second threshold is 16.

Clause 77. The method of any of clauses 1-3, wherein if a value of the width of the video unit multiplying the height of the video unit is larger than or equal to a third threshold, the at least one NN filter model is applied in the RDO process.

Clause 78. The method of clause 77, wherein the third threshold is 64.

Clause 79. The method of any of clauses 1-3, wherein if a value of the width of the video unit multiplying the height of the video unit is less than or equal to a fourth threshold, the at least one NN filter model is applied in the RDO process.

Clause 80. The method of clause 79, wherein the fourth threshold is 4094.

Clause 81. The method of any of clauses 1-3, further comprising: determining whether to and/or the approach to apply the at least one NN filter in the RDO process based on color components.

Clause 82. The method of clause 81, wherein the at least one NN filter model is only applied in a certain color component.

Clause 83. The method of clause 82, wherein the certain component is Luma component or Chroma component.

Clause 84. The method of clause 81, wherein the at least one NN filter model is applied for all color components.

Clause 85. The method of any of clauses 1-3, further comprising: determining whether to and/or the approach to apply the at least one NN filter in the RDO process based on a rate distortion cost without NN filter model.

Clause 86. The method of clause 85, wherein if a first rate distortion cost of a first coding mode is higher than or equal to a second rate distortion cost of a second coding mode multiplied a first factor, the at least one NN filter is not applied.

Clause 87. The method of clause 86, wherein the first factor is one of: 1.0, 1.001, 1.005, 1.05, or 1.01.

Clause 88. The method of any of clauses 85-87, wherein if a second rate distortion cost of a second coding mode is higher than or equal to a first rate distortion cost of a first coding mode multiplied a second factor, the at least one NN filter is not applied.

Clause 89. The method of clause 88, wherein the second factor is one of: 1.0, 1.001, 1.005, 1.05, or 1.01.

Clause 90. The method of any of clauses 85-89, wherein if a first rate distortion cost of a first coding mode is higher than or equal to a second rate distortion cost of a second coding mode multiplied a first factor, or if a second rate distortion cost of a second coding mode is higher than or equal to a first rate distortion cost of a first coding mode multiplied a second factor, the at least one NN filter is not applied.

Clause 91. The method of any of clauses 85-90, wherein if a ratio between a first rate distortion cost of a first coding mode and a second rate distortion cost of a second coding mode is higher than or equal to a first ratio threshold, the at least one NN filter model is not applied.

Clause 92. The method of clause 91, wherein the first ratio threshold is one of: 1.0, 1.001, 1.005, 1.05, or 1.01.

Clause 93. The method of any of clauses 85-92, wherein if a ratio between a first rate distortion cost of a first coding mode and a second rate distortion cost of a second coding mode is less than or equal to a second ratio threshold, the at least one NN filter model is not applied.

Clause 94. The method of clause 93, wherein the second ratio threshold is one of: 1.0, 1.001, 1.005, 1.05, or 1.01.

Clause 95. The method of any of clauses 85-94, wherein if a ratio between a first rate distortion cost of a first coding mode and a second rate distortion cost of a second coding mode is higher than or equal to a first ratio threshold or if a ratio between a first rate distortion cost of a first coding mode and a second rate distortion cost of a second coding mode is less than or equal to a second ratio threshold, the at least one NN filter is not applied.

Clause 96. The method of any of clauses 85-95, wherein the at least one NN filter is not applied, if one of the followings is satisfied: a first rate distortion cost of a first coding mode is equal to a first cost threshold and a second rate distortion of a second coding mode is equal to a second cost threshold, the first rate distortion cost is smaller than the first cost threshold and the second rate distortion is smaller than the second cost threshold, or the first rate distortion cost is higher than the first cost threshold and the second rate distortion is higher than the second cost threshold.

Clause 97. The method of any of clauses 85-95, wherein the at least one NN filter is applied, if one of the followings is satisfied: a first rate distortion cost of a first coding mode is equal to a first cost threshold and a second rate distortion of a second coding mode is equal to a second cost threshold, the first rate distortion cost is smaller than the first cost threshold and the second rate distortion is smaller than the second cost threshold, or the first rate distortion cost is higher than the first cost threshold and the second rate distortion is higher than the second cost threshold.

Clause 98. The method of clause 96 or 97, wherein the first cost threshold or the second cost threshold is equal to MAX_DOUBLE which is a default value, or wherein the first cost threshold or the second cost threshold is equal to 1.7e+308.

Clause 99. The method of any of clauses 85-98, wherein the at least one NN filer for a first coding mode and a second coding mode is applied according to a predefined order or an adaptive order.

Clause 100. The method of clause 99, wherein an order of applying the at least one NN filer for the first coding mode and the second coding mode is dependent on at least one of: a coding mode of the video unit and coding statistics of the video unit.

Clause 101. The method of clause 99, wherein an order of applying the at least one NN filer for the first coding mode and the second coding mode is dependent on a first rate distortion cost of a first coding mode and a second rate distortion of a second coding mode.

Clause 102. The method of clause 101, wherein if the first rate distortion cost of the first coding mode is higher than or equal to the second rate distortion cost of the second coding mode, applying the at least one NN filter to the first coding mode has a higher priority than applying the at least one NN filter to the second coding mode.

Clause 103. The method of clause 101, wherein if the second rate distortion cost of the second coding mode is higher than or equal to the first rate distortion cost of the first coding mode, applying the at least one NN filter to the first coding mode has a higher priority than applying the at least one NN filter to the second coding mode.

Clause 104. The method of any of clauses 85-103, wherein a first rate distortion cost of a first coding mode is equal to the RDO criterion in the RDO process.

Clause 105. The method of any of clauses 85-104, wherein a second rate distortion cost of a second coding mode is equal to the RDO criterion in the RDO process.

Clause 106. The method of clause 104 or 105, wherein the distortion in the RDO criterion is equal to the distortion without NN filter model.

Clause 107. The method of any of clauses 85-106, wherein at least one of the first threshold, the second threshold, the third threshold, the fourth threshold, the first cost threshold, or the second cost threshold is set according to temporal layers, or wherein at least one of the first threshold, the second threshold, the third threshold, the fourth threshold, the first cost threshold, or the second cost threshold is set according to the QP, or wherein at least one of the first threshold, the second threshold, the third threshold, the fourth threshold, the first cost threshold, or the second cost threshold is set according to a slice type, or wherein at least one of the first threshold, the second threshold, the third threshold, the fourth threshold, the first cost threshold, or the second cost threshold is set according to a configuration of the video unit.

Clause 108. The method of any of clauses 1-3, further comprising: determining whether to and/or the approach to apply the at least one NN filter in the RDO process based on a rate distortion cost without NN filter model and a rate distortion cost with NN filter.

Clause 109. The method of clause 108, wherein whether to apply the at least one NN filter model for a first coding mode is dependent on a rate distortion cost of the first coding mode without NN filter model and a rate distortion cost of a second coding mode with NN filter model.

Clause 110. The method of clause 108, wherein a rate distortion cost of the first coding mode without NN filter model is equal to the RDO criterion in the RDO process.

Clause 111. The method of clause 110, wherein the distortion in the RDO criterion is equal to the distortion without NN filter model.

Clause 112. The method of clause 108, wherein a rate distortion cost of a second coding mode with NN filter model is equal to the RDO criterion in the RDO process.

Clause 113. The method of clause 112, wherein the distortion in the RDO criterion is equal to a minimal value of the distortion without NN filter model and the distortion with the n-th NN filter model, or wherein the distortion in the RDO criterion is equal to the distortion with the n-th NN filter model.

Clause 114. The method of clause 108, wherein if a rate distortion cost of the first coding mode without NN filter model is higher than or equal to a rate distortion cost of a second coding mode with NN filter model multiplied a first scaling factor, the at least one NN filter is not applied for the first coding mode.

Clause 115. The method of any of clauses 108-114, wherein if a rate distortion cost of a second coding mode with NN filter model multiplied a second scaling factor is higher than or equal to a rate distortion cost of the first coding mode without NN filter model, the at least one NN filter is not applied for the first coding mode.

Clause 116. The method of any of clauses 108-114, wherein if a rate distortion cost of the first coding mode without NN filter model is higher than or equal to a rate distortion cost of a second coding mode with NN filter model multiplied a first scaling factor, or if the rate distortion cost of the second coding mode with NN filter model multiplied a second scaling factor is higher than or equal to the rate distortion cost of the first coding mode without NN filter model, the at least one NN filter is not applied for the first coding mode.

Clause 117. The method of any of clauses 108-114, wherein if a ratio between a rate distortion cost of the first coding mode without NN filter model and a rate distortion cost of a second coding mode with NN filter model is higher than or equal to a first ratio threshold, the at least one NN filter model is not applied.

Clause 118. The method of any of clauses 108-114, wherein if a ratio between a rate distortion cost of the first coding mode without NN filter model and a rate distortion cost of a second coding mode with NN filter model is less than or equal to a second ratio threshold, the at least one NN filter model is not applied.

Clause 119. The method of any of clauses 108-114, wherein if a ratio between a rate distortion cost of the first coding mode without NN filter model and a rate distortion cost of a second coding mode with NN filter model is higher than or equal to a first ratio threshold, or if a ratio between the rate distortion cost of the first coding mode without NN filter model and the rate distortion cost of the second coding mode with NN filter model is less than or equal to a second ratio threshold, the at least one NN filter is not applied.

Clause 120. The method of any of clauses 108-119, wherein at least one of: the first scaling factor, the second scaling factor, the first ratio threshold, or the second ratio threshold is set according to temporal layers, or wherein at least one of: the first scaling factor, the second scaling factor, the first ratio threshold, or the second ratio threshold is set according to the QP, or wherein at least one of: the first scaling factor, the second scaling factor, the first ratio threshold, or the second ratio threshold is set according to a slice type, or wherein at least one of: the first scaling factor, the second scaling factor, the first ratio threshold, or the second ratio threshold is set according to a configuration of the video unit.

Clause 121. The method of any of clauses 1-3, wherein the at least one NN filter is only applied to partial samples of a block in the RDO process.

Clause 122. The method of clause 121, wherein the at least one NN filter is only applied to a center subblock in the block.

Clause 123. The method of clause 122, wherein a width of the subblock is equal to half of width of the block, and a height of the subblock is equal to half of height of the block.

Clause 124. The method of clause 122, wherein a width of the subblock is equal to three quarters of width of the block, and a height of the subblock is equal to three quarters of height of the block.

Clause 125. The method of any of clauses 1-3, further comprising: determining whether to and/or the approach to apply the at least one NN filter in the RDO process based on temporal layers.

Clause 126. The method of clause 125, wherein the at least one NN filter is applied to the temporal layer with ID which is greater than K, or wherein the at least one NN filter is applied to the temporal layer with ID which is smaller than K, wherein K is an integer number.

Clause 127. The method of clause 126, wherein K is equal to one of 0, 1, 2, 3, 4, 5, or 6.

Clause 128. The method of any of clauses 1-3, further comprising: determining whether to and/or the approach to apply the at least one NN filter in the RDO process based on coding statistics of sub coding units.

Clause 129. The method of clause 128, wherein if the at least one NN filter is applied to a portion or all of the sub coding units, the at least one NN filter is not applied to the video unit, or wherein if the at least one NN filter is applied to the portion or all of the sub coding units, the at least one NN filter is applied to the video unit.

Clause 130. The method of clause 128, wherein if at least one of: rate-distortion costs or distortions of the portion or all of the sub coding units are available, the at least one NN filter is not applied to the video unit, or wherein if at least one of: rate-distortion costs or distortions of the portion or all of the sub coding units are available, the at least one NN filter is applied to the video unit.

Clause 131. The method of any of clauses 1-130, wherein the conversion includes encoding the video unit into the bitstream.

Clause 132. The method of any of clauses 1-130, wherein the conversion includes decoding the video unit from the bitstream.

Clause 133. An apparatus for video processing comprising a processor and a non-transitory memory with instructions thereon, wherein the instructions upon execution by the processor, cause the processor to perform a method in accordance with any of clauses 1-132.

Clause 134. A non-transitory computer-readable storage medium storing instructions that cause a processor to perform a method in accordance with any of clauses 1-132.

Clause 135. A non-transitory computer-readable recording medium storing a bitstream of a video which is generated by a method performed by an apparatus for video processing, wherein the method comprises: determining whether to apply at least one neural network (NN) filter model or determine a rate distortion cost during a rate distortion optimization (RDO) process of a video unit of the video based on at least one of: a distortion without NN filter model, a distortion with n-th NN filter model, a combination of distortions of a plurality of NN filter models, or coding statistics of the video unit, and wherein n is an integer number; determining a coding mode of the video unit based on a rate distortion optimization (RDO) criterion in the RDO process; and generating the bitstream based on the coding mode.

Clause 136. A method for storing a bitstream of a video, comprising: determining whether to apply at least one neural network (NN) filter model or determine a rate distortion cost during a rate distortion optimization (RDO) process of a video unit of the video based on at least one of: a distortion without NN filter model, a distortion with n-th NN filter model, a combination of distortions of a plurality of NN filter models, or coding statistics of the video unit, and wherein n is an integer number; determining a coding mode of the video unit based on a rate distortion optimization (RDO) criterion in the RDO process; generating the bitstream based on the coding mode; and storing the bitstream in a non-transitory computer-readable recording medium.

### Example Device

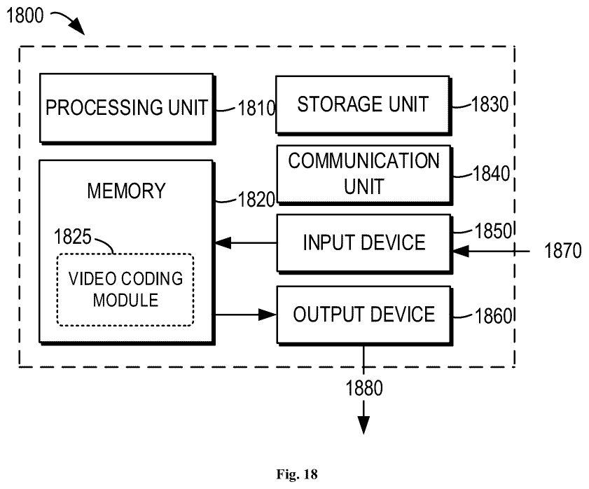

FIG. 18 illustrates a block diagram of a computing device 1800 in which various embodiments of the present disclosure can be implemented. The computing device 1800 may be implemented as or included in the source device 110 (or the video encoder 114 or 200) or the destination device 120 (or the video decoder 124 or 300).

It would be appreciated that the computing device 1800 shown in FIG. 18 is merely for purpose of illustration, without suggesting any limitation to the functions and scopes of the embodiments of the present disclosure in any manner.

As shown in FIG. 18, the computing device 1800 includes a general-purpose computing device 1800. The computing device 1800 may at least comprise one or more processors or processing units 1810, a memory 1820, a storage unit 1830, one or more communication units 1840, one or more input devices 1850, and one or more output devices 1860.

In some embodiments, the computing device 1800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1800 can support any type of interface to a user (such as “wearable” circuitry and the like).

The processing unit 1810 may be a physical or virtual processor and can implement various processes based on programs stored in the memory 1820. In a multi-processor system, multiple processing units execute computer executable instructions in parallel so as to improve the parallel processing capability of the computing device 1800. The processing unit 1810 may also be referred to as a central processing unit (CPU), a microprocessor, a controller or a microcontroller.

The computing device 1800 typically includes various computer storage medium. Such medium can be any medium accessible by the computing device 1800, including, but not limited to, volatile and non-volatile medium, or detachable and non-detachable medium. The memory 1820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1830 may be any detachable or non-detachable medium and may include a machine-readable medium such as a memory, flash memory drive, magnetic disk or another other media, which can be used for storing information and/or data and can be accessed in the computing device 1800.

The computing device 1800 may further include additional detachable/non-detachable, volatile/non-volatile memory medium. Although not shown in FIG. 18, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1840 communicates with a further computing device via the communication medium. In addition, the functions of the components in the computing device 1800 can be implemented by a single computing cluster or multiple computing machines that can communicate via communication connections. Therefore, the computing device 1800 can operate in a networked environment using a logical connection with one or more other servers, networked personal computers (PCs) or further general network nodes.

The input device 1850 may be one or more of a variety of input devices, such as a mouse, keyboard, tracking ball, voice-input device, and the like. The output device 1860 may be one or more of a variety of output devices, such as a display, loudspeaker, printer, and the like. By means of the communication unit 1840, the computing device 1800 can further communicate with one or more external devices (not shown) such as the storage devices and display device, with one or more devices enabling the user to interact with the computing device 1800, or any devices (such as a network card, a modem and the like) enabling the computing device 1800 to communicate with one or more other computing devices, if required. Such communication can be performed via input/output (I/O) interfaces (not shown).

In some embodiments, instead of being integrated in a single device, some or all components of the computing device 1800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1800 may be used to implement video encoding/decoding in embodiments of the present disclosure. The memory 1820 may include one or more video coding modules 1825 having one or more program instructions. These modules are accessible and executable by the processing unit 1810 to perform the functionalities of the various embodiments described herein.

In the example embodiments of performing video encoding, the input device 1850 may receive video data as an input 1870 to be encoded. The video data may be processed, for example, by the video coding module 1825, to generate an encoded bitstream. The encoded bitstream may be provided via the output device 1860 as an output 1880.

In the example embodiments of performing video decoding, the input device 1850 may receive an encoded bitstream as the input 1870. The encoded bitstream may be processed, for example, by the video coding module 1825, to generate decoded video data. The decoded video data may be provided via the output device 1860 as the output 1880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, whether to apply at least one neural network (NN) filter model or determine a rate distortion cost during a rate distortion optimization (RDO) process of the video unit based on at least one of: a distortion without NN filter model, a distortion with n-th NN filter model, a combination of distortions of a plurality of NN filter models, or coding statistics of the video unit, and wherein n is an integer number;
determining a coding mode of the video unit based on a rate distortion optimization (RDO) criterion in the RDO process; and
performing the conversion based on the coding mode.

2. The method of claim 1, further comprising:
determining an approach to apply the at least one neural network (NN) filter model or determine the rate distortion cost during the RDO process of the video unit based on at least one of: the distortion without NN filter model, the distortion with n-th NN filter model, or the combination of distortions of the plurality of NN filter models.

3. The method of claim 1, wherein the distortion with the n-th NN filter model is derived by comparing filter reconstruction samples which are filtered by the n-th NN filter model with original samples, and
wherein the distortion in the RDO criterion is represented as J=D+lambda*R, wherein D represents a distortion, lambda represents a coefficient parameter, R represents a rate associated with a candidate coding mode.

4. The method of claim 1, wherein the distortion in the RDO criterion is the distortion with the n-th NN filter model, and/or
wherein the distortion in the RDO criterion is a minimal value of the distortion without NN filter model and the distortion with the n-th NN filter model, and/or
wherein the distortion in the RDO criterion is a distortion with a best NN filter model, and/or
wherein the distortion in the RDO criterion is a minimal value of distortion without NN filter model and a distortion with a best NN filter model, and/or
wherein the distortion in the RDO criterion is the distortion without NN filter model multiplied a scaling factor, and/or
wherein the distortion in the RDO criterion is derived according to the distortion without NN filter model and the distortion with the n-th NN filter model.

5. The method of claim 4, wherein n is one of: 1, 2, 3, or
wherein the best NN filter model is selected by distortion, or
wherein the best NN filter model is a default one, or
wherein the scaling factor is one of 1.0, 0.9, or 1.1.

6. The method of claim 4, wherein the distortion in the RDO criterion is derived as:
$$D = {f}_{0} * {D}_{ORG} + {f}_{1} * {D}_{NNLF}^{n} ,$$
and
wherein D represents the distortion in the RDO criterion, f₀ represents a first scaling factor, f₁ represents a second scaling factor, D_{ORG} represents the distortion without NN filter model, and Dⁿ_{NNLF} represents the distortion with the n-th NN filter model, or
wherein the distortion in the RDO criterion is derived as:
$$min ( {f}_{0} * {D}_{ORG} , {f}_{1} * {D}_{NNLF}^{n} ) ,$$
wherein D represents the distortion in the RDO criterion, f₀ represents a first scaling factor, f₁ represents a second scaling factor, D_{ORG} represents the distortion without NN filter model, and Dⁿ_{NNLF} represents the distortion with the n-th NN filter model.

7. The method of claim 1, wherein the distortion in the RDO criterion is a combination of one or more of:
the distortion with the n-th NN filter model,
a minimal value of the distortion without NN filter model and the distortion with the n-th NN filter model,
a distortion with a best NN filter model,
a minimal value of distortion without NN filter model and a distortion with a best NN filter model,
the distortion without NN filter model multiplied a scaling factor, or
a derivation according to the distortion without NN filter model and the distortion with the n-th NN filter model.

8. The method of claim 7, wherein the combination is dependent on coding statistics of the video unit, and/or
wherein if one or all of candidate modes are not partitioning mode, the distortion in the RDO criterion is a combination of at least one of: a distortion with p-th NN filter model or the distortion without NN filter model, wherein p is an integer number, and/or
wherein if one or all of candidate modes are partitioning modes, the distortion in the RDO criterion is a combination of at least one of: a distortion with q-th NN filter model, a distortion with p-th NN filter model, or the distortion without NN filter model, wherein p and q are integer numbers, and/or
wherein the combination is dependent on at least one of: usage of q-th NN filter model or usage of p-th NN filter model, wherein p and q are integer numbers, and/or
wherein an approach of determining the distortion in the RDO criterion is applied according to a predefined order or an adaptive order.

9. The method of claim 1, wherein the distortion in the RDO criterion is the minimal value of distortions with m NN filter models, wherein m is an integer number, or
wherein the distortion in the RDO criterion is a minimal value of the distortion without NN filter model and distortions with m NN filter models, wherein m is an integer number, and/or
wherein the distortion in the RDO criterion is a combination of the distortion without NN filter model and distortions with m NN filter models, wherein m is an integer number, and/or
wherein the distortion without NN filter model is dependent on another filter which is different with the at least one NN filter model.

10. The method of claim 9, wherein m is an available number of constructed NN filter models, and/or
wherein m is dependent on a type of video unit, and/or
wherein m is dependent on a signaled parameter of video unit, and/or
wherein m is a default value, and/or
wherein m is one of: 0, 1, 2, 3, or 4, and/or
wherein the distortion with the other filter is derived by comparing filter reconstruction samples which are filtered by the other filter with original samples, and/or
wherein the other filter is applied on reconstruction samples before the at least one NN filter model, and/or
wherein the at least one NN filter model is applied after the other filter, and/or
wherein the distortion without NN filter model is the distortion with the other filter multiplied a scaling factor, and/or
wherein the distortion without NN filter model is a combination of the distortions with a plurality of other filters.

11. The method of claim 1, wherein an input of the at least one NN filter model in the RDO process include a signal from at least one of: a current block or a neighboring block, and/or wherein the coding statistics comprises at least one of:
a prediction mode,
QP,
a temporal layer,
a slice type, or
a dimension of the video unit.

12. The method of claim 1, wherein if a width of the video unit is less than or equal to a first threshold and a height of the video unit is less than or equal to a second threshold, the at least one NN filter model is applied in the RDO process, and/or
wherein if a width of the video unit is larger than or equal to a first threshold and a height of the video unit is larger than or equal to a second threshold, the at least one NN filter model is applied in the RDO process, and/or
wherein if a value of the width of the video unit multiplying the height of the video unit is larger than or equal to a third threshold, the at least one NN filter model is applied in the RDO process, and/or
wherein if a value of the width of the video unit multiplying the height of the video unit is less than or equal to a fourth threshold, the at least one NN filter model is applied in the RDO process.

13. The method of claim 1, further comprising:
determining whether to and/or the approach to apply the at least one NN filter in the RDO process based on color components, and/or
determining whether to and/or the approach to apply the at least one NN filter in the RDO process based on a rate distortion cost without NN filter model, and/or
determining whether to and/or the approach to apply the at least one NN filter in the RDO process based on a rate distortion cost without NN filter model and a rate distortion cost with NN filter, and/or determining whether to and/or the approach to apply the at least one NN filter in the RDO process based on temporal layers.

14. The method of claim 1, wherein the at least one NN filter is only applied to partial samples of a block in the RDO process.

15. The method of claim 1, further comprising:
determining whether to and/or the approach to apply the at least one NN filter in the RDO process based on coding statistics of sub coding units.

16. The method of claim 15, wherein if the at least one NN filter is applied to a portion or all of the sub coding units, the at least one NN filter is not applied to the video unit, or
wherein if the at least one NN filter is applied to the portion or all of the sub coding units, the at least one NN filter is applied to the video unit, and/or
wherein if at least one of: rate-distortion costs or distortions of the portion or all of the sub coding units are available, the at least one NN filter is not applied to the video unit, or
wherein if at least one of: rate-distortion costs or distortions of the portion or all of the sub coding units are available, the at least one NN filter is applied to the video unit.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to:
determine, for a conversion between a video unit of a video and a bitstream of the video, whether to apply at least one neural network (NN) filter model or determine a rate distortion cost during a rate distortion optimization (RDO) process of the video unit based on at least one of: a distortion without NN filter model, a distortion with n-th NN filter model, a combination of distortions of a plurality of NN filter models, or coding statistics of the video unit, and wherein n is an integer number;
determine a coding mode of the video unit based on a rate distortion optimization (RDO) criterion in the RDO process; and
perform the conversion based on the coding mode.

19. A non-transitory computer-readable storage medium storing instructions that cause a processor to:
determine, for a conversion between a video unit of a video and a bitstream of the video, whether to apply at least one neural network (NN) filter model or determine a rate distortion cost during a rate distortion optimization (RDO) process of the video unit based on at least one of: a distortion without NN filter model, a distortion with n-th NN filter model, a combination of distortions of a plurality of NN filter models, or coding statistics of the video unit, and wherein n is an integer number;
determine a coding mode of the video unit based on a rate distortion optimization (RDO) criterion in the RDO process; and
perform the conversion based on the coding mode.

20. A non-transitory computer-readable recording medium storing a bitstream of a video which is generated by a method performed by an apparatus for video processing, wherein the method comprises:
determining whether to apply at least one neural network (NN) filter model or determine a rate distortion cost during a rate distortion optimization (RDO) process of a video unit of the video based on at least one of: a distortion without NN filter model, a distortion with n-th NN filter model, a combination of distortions of a plurality of NN filter models, or coding statistics of the video unit, and wherein n is an integer number;
determining a coding mode of the video unit based on a rate distortion optimization (RDO) criterion in the RDO process; and
generating the bitstream based on the coding mode.
